(19) United States
(12) Patent Application Publication
(10) Pub. No.: US 2025/0237017 A1
(43) Pub. Date: Jul. 24, 2025

(54) NON-SHEAR SENSITIVE SURFACE SOFTENING COMPOSITIONS

(71) Applicant: The Procter & Gamble Company, Cincinnati, OH (US)

(72) Inventors: Cahit EYLEM, West Chester, OH (US); Marc Johan DECLERCQ, Strombeek-Bever (BE); Stephanie Michelle PROCTOR, Union, KY (US); Mary Katherine HAMILTON, Deerfield Township, OH (US); Ty Gerald NOE, Loveland, OH (US)

(21) Appl. No.: 19/032,477

(22) Filed: Jan. 21, 2025

Related U.S. Application Data
(60) Provisional application No. 63/623,387, filed on Jan. 22, 2024.

(51) Int. Cl. D21H 21/22; C09D 7/20; C09D 7/63; D21H 19/12; D21H 27/00

(52) U.S. Cl. CPC D21H 21/22; C09D 7/20; C09D 7/63; D21H 19/12; D21H 27/002

(57) ABSTRACT

Surface softening compositions, such as non-shear sensitive surface softening compositions suitable for application to fibrous structures, such as sanitary tissue products.

### FIELD OF THE INVENTION

The present invention relates to surface softening compositions, for example surface softening compositions suitable for application to fibrous structures, such as sanitary tissue products.

### BACKGROUND OF THE INVENTION

Known softening actives, for example Ditallow Ethyl Ester Dimethyl Ammonium Methyl Sulfate (DEEDMAMS) at 40% active, provide some softening for sanitary tissue products, but consumers desire more softness. Further, the water present within the aqueous quaternary ammonium compound compositions is deleterious for fibrous structure properties (such as those in sanitary tissue products), for example—loss in tensile strength, stretch, such as MD stretch, and structure, such as embossments, of the fibrous structures.

Further, surface softening compositions comprising such known softener actives exhibit additional negatives that make them challenging for formulators to utilize as surface softening compositions for sanitary tissue products. Such additional negatives include shear sensitivity that result in material thickening, i.e viscosity increase, during material handling and application, making it unacceptable for surface application to fibrous structures, via non-spray applications, such as via extrusion dies, in a converting application of a papermaking operation. Additional negatives include storage shelf life of less than six months, low/high temperature instability, process hygiene negatives, such as build-up on process equipment surfaces during surface applications on tissue products, and susceptibility to microbe growth.

The problems associated with the known surface softening compositions is believed to be due to the chemical nature of the known softener actives. The known softener actives fail to be non-shear sensitive, as measured according to the Non-Shear Sensitive Test Method described herein are usually solids at 25° C.

Prior art softening compositions, such as concentrated fabric softening compositions containing ester or amide linked fabric softener actives and specific principal solvents are described in U.S. Pat. No. 751,990, 5,747,443, and 6,875,735. The prior art discloses the need to minimize and manage the increase in viscosity upon dilution during in-use and the need for the use of electrolytes in disclosed fabric softening compositions to create shear-sensitive and shear thinning compositions for easier dispensing, improved performance and reduced fabric staining incidents.

The process to apply surface softening compositions to fibrous structures uses a very high shear environment, making a shear stable composition desirable. U.S. Pat. No. 751,990, 5,747,443, and 6,875,735 fail to describe viscosity and shear-stability of the fabric softening compositions and not bound by the theory, given the complexity of these fabric softening compositions (e.g. presence of perfume etc), they are not suitable for fibrous structure applications and likely to be destabilized during the high shear tissue application slot coating process and do not deliver desired softness benefits on tissue products.

What is needed is a shear resistant low viscosity and highly concentrated surface softening composition with a shelf-life longer than six months that can be prepared by processing at room temperature for use in fibrous structures, such as sanitary tissue. It is also desirable that tissue softening compositions have as high viscosity as possible that is maintained throughout the application process to enable deposition and retention of the softener on the surface for optimum softness benefits.

### SUMMARY OF THE INVENTION

A surface softening composition is provided that comprises water; solvent; at least 25% by weight of a softener active; and wherein the composition is non-shear sensitive.

A fibrous structure is provided that comprises one or more plies and a surface softening composition comprising water, solvent, at least 25% by weight of a softener active, and wherein the composition is non-shear sensitive.

A method for treating a fibrous structure is provided that comprises the steps of providing a fibrous structure; and applying a surface softening composition comprising water; solvent; at least 25% by weight of a softener active; and wherein the composition is non-shear sensitive to at least one surface of the fibrous structure.

### BRIEF DESCRIPTION OF THE DRAWINGS

While the specification concludes with claims particularly pointing out and distinctly claiming the subject matter that is regarded as the present disclosure, it is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of elements in any of the exemplary embodiments, except as may be explicitly delineated in the corresponding written description. None of the drawings are necessarily to scale.

FIG. 1. Shows a rheology curve of softening composition prepared in Example 1.

FIG. 2. Shows a rheology curve of softening composition prepared in Example 2.

FIG. 3. Shows a rheology curve of softening composition prepared in Example 3.

FIG. 4. Shows pictures of diluted batches from softening composition of 60% activity showing phase stability when solvent/water ratio is maintained above 0.9.

FIG. 5. Shows a rheology curve of softening composition (SAMPLE 1) at different temperatures.

FIG. 6. Shows a rheology curve of softening composition (SAMPLE 2) at different temperatures.

FIG. 7. Shows a rheology curve of softening composition (Comparative SAMPLE 1) showing shear thinning behavior.

FIG. 8. Shows a rheology curve of softening composition (Comparative SAMPLE 2) showing temperature sensitive shear thinning behavior.

FIG. 9. Shows pictures of finished batches showing thick and gel-like phase behavior.

FIG. 10. Shows a rheology curve of softening composition (Comparative SAMPLE 5) showing shear thinning behavior.

FIG. 11. Shows pictures of finished material showing thick and gel-like phase behavior compared to starting material.

FIG. 12. Shows rheology curve of softening composition (Comparative SAMPLE 7) showing shear thinning behavior.

FIG. 13. Shows rheology curve of softening composition (Comparative SAMPLE 8) showing shear thinning behavior.

### DETAILED DESCRIPTION OF THE INVENTION

The present invention relates to surface softening compositions, for example surface softening compositions suitable for application to fibrous structures, such as sanitary tissue products, for example toilet tissue or facial tissue and more particularly to non-shear sensitive compositions, for example non-shear sensitive compositions that comprise at least 25% by weight of a quaternary ammonium compound, methods for making same, sanitary tissue products comprising same, and methods for making such sanitary tissue products. These compositions are characterized by shear insensitivity, water/solvent ratio, temperature stability, and non-microbial susceptibility.

“Non-shear sensitive emulsion” as used herein means an emulsion having a power-law exponent −0.01≥n−1≥0.01 in fitted viscosity curves over the shear rate range of 1 s⁻¹-1000 s⁻¹. More specifically it refers to an emulsion where when the viscosity plotted as a function of shear rate is fitted to a power-law model η=k\dot{γ}ⁿ⁻¹, where k is the consistency index and n−1 is the power-law exponent, a “non-shear sensitive emulsion” will have a power-law exponent where −0.01≥n−1≥0.01.

The surface softening compositions disclosed herein are non-shear sensitive when exposed to shear rates from 0.1 sec-1 to up to 1,000,000 sec-1 above 20° C.

These compositions exhibit non-shear sensitive viscosity at 25° C. of from about 25 cP to about 300 cP as measured according to the Viscosity Test Method.

The surface softening compositions disclosed herein showed excellent freeze-thaw properties maintaining shear stable low viscosity, clear and translucent phase stability when cycled between freeze temperatures ˜0° C. and room temperature ˜25° C. The surface softening compositions also exhibits high temperature stability up to 70° C. maintaining shear stable low viscosity, clear and translucent phase properties. These surface compositions unlike traditional softener emulsions/dispersions can be stored at room temperatures ˜25° C. without the need for agitation up to 3 years.

Water activity is defined as the ratio of the vapor pressure of water in a material (p) to the vapor pressure of pure water (po) at the same temperature. Relative humidity of air is defined as the ratio of vapor pressure of air to its saturation vapor pressure. When vapor pressure and temperature equilibrium are obtained, the water activity is equal to the relative humidity of air surrounding the sample in a sealed measurement chamber. Multiplication of water activity by 100 gives the equilibrium relative humidity (ERH) in percent.

$$aw = p / po = ERH ( \% ) / 100$$

The determination of the water activity of formulations aids in the decisions relating to the following (1) Providing a measurement for the rationale of reducing the frequency of microbial testing and screening for objectionable microorganisms for product release and susceptibility testing; (2) Reducing the microsusceptibility of formulations (especially liquids); (3) Optimizing product formulations to improve the antimicrobial effectiveness of preservative systems.

Reduced water activity (aw) will greatly assist in the prevention of microbial proliferation in formulations and manufacturing steps.

Water activity is directly related to amount of water present and solvent/water ratio in surface softener compositions. Preferred water activity is less than 0.6, preferably less than 0.4, more preferably less than 0.2 to about 0.05.

“Basis Weight” as used herein is the weight per unit area of a sample reported in lbs/3000 ft² or g/m² (gsm) and is measured according to the respective Basis Weight Test Method described herein.

“Machine Direction” or “MD” as used herein means the direction parallel to the flow of the fibrous structure through the web (fibrous structure) making machine and/or sanitary tissue product manufacturing equipment.

“Cross Machine Direction” or “CD” as used herein means the direction parallel to the width of the web (fibrous structure) making machine and/or sanitary tissue product manufacturing equipment and perpendicular to the machine direction.

“Ply” as used herein means an individual, integral web (fibrous structure).

“Plies” as used herein means two or more individual, integral webs (fibrous structures) disposed in a substantially contiguous, face-to-face relationship with one another, forming a multi-ply fibrous structure and/or multi-ply sanitary tissue product. It is also contemplated that an individual, integral web (fibrous structure) can effectively form a multi-ply fibrous structure, for example, by being folded on itself.

“Embossed” as used herein with respect to a web and/or sanitary tissue product means that a web and/or sanitary tissue product of the present invention has been subjected to a process which converts a smooth surfaced web and/or sanitary tissue product to a decorative surface by replicating a design on one or more emboss rolls, which form a nip through which the web and/or sanitary tissue product passes. Embossed does not include creping, microcreping, printing or other processes that may also impart a texture and/or decorative pattern to a web and/or sanitary tissue product.

“Differential density”, as used herein, means a web and/or sanitary tissue product of the present invention that comprises one or more regions of relatively low fiber density, which are referred to as pillow regions, and one or more regions of relatively high fiber density, which are referred to as knuckle regions.

“Densified”, as used herein means a portion of a web and/or sanitary tissue product of the present invention that is characterized by regions of relatively high fiber density (knuckle regions).

“Non-densified”, as used herein, means a portion of a web and/or sanitary tissue product of the present invention that exhibits a lesser density (one or more regions of relatively lower fiber density) (pillow regions) than another portion (for example a knuckle region) of the web and/or sanitary tissue product.

“Creped” as used herein means creped off of a Yankee dryer or other similar roll and/or tissue creped and/or belt creped. Rush transfer of a web (fibrous structure) alone does not result in a “creped” fibrous structure or “creped” sanitary tissue product for purposes of the present invention.

As used herein, the articles including “a” and “an” when used in a claim, are understood to mean one or more of what is claimed or described.

As used herein, the terms “include”, “includes” and “including” are meant to be non-limiting.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, the word “or” when used as a connector of two or more elements is meant to include the elements individually and in combination; for example X or Y, means X or Y or both.

All measurements referred to herein are made at about 25° C. (i.e. room temperature) unless otherwise specified.

By “μm” or “microns” as used herein is meant micrometer.

A “Surface Softening Composition” as used herein comprises at least one softener active, solvent, and water.

### Softener Actives

Typical levels of incorporation of the softener active in the surface softening composition are from about 2% to about 80% by weight, preferably from about 5% to about 75%, more preferably from about 15% to about 70%, and even more preferably from about 25% to about 70%, by weight of the composition, and preferably is biodegradable as disclosed hereinafter. These softening actives are novel having unobvious properties when formulated into aqueous, concentrated surface softener compositions of the traditional type that are dispersions or suspensions of surface softener actives.

In embodiments, softener actives with alkyl chains that are unsaturated or branched are particularly well suited for use in clear, translucent, and shear stable surface softening compositions. In embodiments an indicator of the suitability of softener active, softener actives or mixtures of softener actives for use in the softener compositions of this invention is the iodine value and phase transition temperature. Preferably, the iodine value of suitable softener actives is more than 100, more than 80, or more than 60. In embodiments softening actives have a phase transition temperature of less than 50° C., less than 35° C., less than 20° C., less than 10° C., or is amorphous and has no significant endothermic phase transition in the region negative 50° C. to 100° C. The phase transition temperature can be measured with a Mettler TA3000 differential scanning calorimeter with Mettler TC 10A Processor.

The Softening active can be selected from cationic, nonionic, and/or amphoteric fabric Softening actives. Typical of the cationic softening actives are the quaternary ammonium compounds or amine precursors thereof as described below.

### Diester Quaternary Ammonium Tissue Softener Active Compound (DEQA)

(1) A first type of DEQA preferably comprises, as the principal active, [DEQA (1)] compounds of the formula:

{R₄₋ₘ—N⁺[X—Y—R¹]ₘ}A⁻

### Wherein:

each m is 2 or 3;
each R substituent is either hydrogen, a short chain C₁-C₆, preferably C₁-C₃ alkyl or hydroxyalkyl group, e.g., methyl (most preferred), ethyl, propyl, hydroxyethyl, and the like, Poly (C₂₋₃ alkoxy), preferably polyethoxy, group, benzyl, or mixtures thereof;
each Y is —O—(O)C—, —C(O)—O—, —NR—C(O)—, or —C(O)—NR—; the sum of carbons in each R¹, plus one when Y is —O—(O)C— or —NR—C(O)—, is C₁₂-C₂₂ preferably C₁₄-C₂₀, with each R¹ being a hydrocarbyl, or substituted hydrocarbyl group,
each X is independently —(CH2)n, —CH2-CH(CH3)- or —CH(CH3)-CH2- and
each n is from 1 to about 4, preferably 2;
A⁻ can be any softener-compatible anion, preferably, chloride, bromide, methylsulfate, ethylsulfate, sulfate, and nitrate, more preferably chloride or methyl sulfate (As used herein, the “percent of softener active” containing a given R¹ group is based upon taking a percentage of the total active based upon the percentage that the given R¹ group is, of the total R¹ groups present.)
   and

(2) A second type of DEQA active [DEQA (2)] has the general formula:

[R₃N⁺CH₂CH(YR¹)(CH₂YR¹)]X⁻

wherein each Y, R, R¹, and X⁻ have the same meanings as before. Such compounds include those having the formula:

[CH₃]₃N⁽⁺⁾[CH₂CH(CH₂O(O)CR¹)O(O)CR¹]CH₃SO₄⁽⁻⁾

wherein each R is a methyl or ethyl group and preferably each R¹ is in the range of C₁₅ to C₁₉. As used herein, when the diester is specified, it can include the monoester that is present. The amount of monoester that can be present is the same as in DEQA (1).

These types of agents and general methods of making them are disclosed in U.S. Pat. No. 4,137,180, which is incorporated herein by reference. An example of a preferred DEQA (2) is the “propyl” ester quaternary ammonium tissue softener active having the formula 1,2-di(acyloxy)-3-trimethylammoniopropane chloride, where the acyl is the same as that of FA¹ described below.

(3) A third type softening active has the general formula

[R¹C(O)OC₂H₄]ₘN⁺(R)₄₋ₘX⁻

wherein each R¹ in a compound is a C₅-C₂₁ hydrocarbyl group, preferably having an Iodine Value (IV) from about 60 to about 140 based upon the Iodine Value (IV) of the equivalent fatty acid with the cis/trans ratio preferably being as described hereinafter, m is a number from 1 to 3 on the weight average in any mixture of compounds, each R in a compound is a C₁₋₃ alkyl or hydroxy alkyl group, the total of m and the number of R groups that are hydroxyethyl groups equaling 3, and X is a softener compatible anion, preferably methyl sulfate. Preferably the cis trans isomer ratio of the fatty acid (of the C18:1 component) is at least about 1:1, preferably about 2:1, more preferably about 3:1, and even more preferably about 4:1, or higher.

The tissue softener actives for use herein are typically mixtures of materials. The weight percentages of compounds wherein one (monoester), two (diester), or three (triester) of the triethanolamine hydroxy groups is esterified with a fatty acyl group are as follows: Monoester—from about 12% to about 45%; diester—from about 43% to about 57%; and triester—from about 9% to about 28%. These compounds, as formed and used in the formulation of surface softener compositions, typically contain from about 6% to about 25% by weight of solvent, e.g., from about 3% to about 25% of propylene glycol. In a preferred embodiment the fatty acid fraction and the triethanolamine are present in a molar ratio of from about 1:1 to about 2.5:1.

Preferred cationic, preferably biodegradable quaternary, ammonium tissue softener actives can contain the group —(O)CR¹ which is derived from animal fats, unsaturated, and polyunsaturated, fatty acids, e.g., oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, etc. Non-limiting examples of fatty acids (FA) are listed in U.S. Pat. No. 5,759,990.

Mixtures of fatty acids, and mixtures of FAs that are derived from different fatty acids can be used. Fatty acid can be derived either from animal or vegetable sources. Nonlimiting examples of FA's that can be blended, to form FA's of this invention are as follows:

Fatty Acid Group FA¹FA²FA³

| Fatty Acid Group | FA¹ | FA² | FA³ |
|---|---|---|---|
| C₁₄ | 0 | 0 | 1 |
| C₁₆ | 3 | 11 | 25 |
| C₁₈ | 3 | 4 | 20 |
| C14:1 | 0 | 0 | 0 |
| C16:1 | 1 | 1 | 0 |
| C18:1 | 9 | 27 | 45 |
| C18:2 | 13 | 50 | 6 |
| C18:3 | 1 | 7 | 0 |
| Unknowns | 0 | 0 | 3 |
| Total | 100 | 100 | 100 |
| Iodine Value (IV) | 99 | 125-138 | 56 |
| cis/trans (C18:1) | 5-6 | Not Available | 7 |
| TPU | 14 | 57 | 6 |

FA¹ is a partially hydrogenated fatty acid prepared from canola oil,
FA² is a fatty acid prepared from soy bean oil, and
FA³ is a slightly hydrogenated tallow fatty acid.

Preferred softener actives contain an effective amount of molecules containing two ester linked hydrophobic groups [R¹C(CO)O—], said actives being referred to hereinafter as “DEQA's”, are those that are prepared as a single DEQA from blends of all the different fatty acids that are represented (total fatty acid blend), rather than from blends of mixtures of separate finished DEQA's that are prepared from different portions of the total fatty acid blend.

It is preferred that at least a majority of the fatty acyl groups are unsaturated, e.g., from about 50% to about 100%, preferably from about 55% to about 99%, more preferably from about 60% to about 98%, and that the total level of active containing polyunsaturated fatty acyl groups (TPU) be from 0% to about 30%. The cis/trans ratio for the unsaturated fatty acyl groups is usually important, with the cis/trans ratio being from about 1:1 to about 50:1, the minimum being about 1:1, preferably at least about 3:1, and more preferably from about 4:1 to about 40:1. The unsaturated, including the preferred polyunsaturated, fatty acyl and/or alkylene groups, discussed hereinbefore and hereinafter, surprisingly provide effective softening, but also provide better rewetting characteristics, good antistatic characteristics, and especially, superior recovery after freezing and thawing.

The highly unsaturated materials are also easier to formulate into concentrated premixes that maintain a low viscosity for the neat product composition and are therefore easier to process, e.g., pump, mixing, etc. These highly unsaturated materials (total level of active containing polyunsaturated fatty acyl groups (TPU) being typically from about 3% to about 30%, with only the low amount of solvent that normally is associated with such materials, i.e., from about 5% to about 20%, preferably from about 8% to about 25%, more preferably from about 10% to about 20%, weight of the total softener/solvent mixture, are also easier to formulate into concentrated, stable compositions of the present invention, even at room temperature (approximately 25° C.)s. This ability to process the actives at low temperatures is especially important for the polyunsaturated groups, since it minimizes degradation.

It will be understood that substituents R and R′ can optionally be substituted with various groups. such as alkoxyl or hydroxyl groups, and can be Straight, or branched so long as the R′ groups maintain their basically hydrophobic character.

A preferred long chain DEQA is the DEQA prepared from sources containing high levels of polyunsaturation, i.e., N,N-di(acyl-oxyethyl)-N,N-methylhydroxyethylammonium methyl sulfate, where the acyl is derived from fatty acids containing sufficient polyunsaturation, e.g., mixtures of tallow fatty acids and soybean fatty acids. Another preferred long chain DEQA is the dioleyl (nominally) DEQA, i.e., DEQA in which N,N-di(oleoyl-oxyethyl)-N,N-methylhydroxyethylammonium methyl sulfate is the major ingredient. Preferred sources of fatty acids for such DEQAs are vegetable oils, and/or partially hydrogenated vegetable oils, with high contents of unsaturated, e.g., oleoyl groups.

As used herein, when the DEQA diester (m=2) is specified, it can also include the monoester (m=1) or triester (m=3). Preferably, at least about 30% of the DEQA is in the diester form, and from 0% to about 40% can be DEQA monoester, e.g., there are three R groups and one R¹ group.

The above compounds can be prepared using standard reaction chemistry. In one synthesis of a diester variation of DTDMAC, triethanolamine of the formula N(CH₂CH₂OH)₃ is esterified, preferably at two hydroxyl groups, with an acid chloride of the formula R¹C(O)CI, to form an amine which can be made cationic by acidification (one R is H) to be one type of softener, or then quaternized with an alkyl halide, RX, to yield the desired reaction product (wherein R and R¹ are as defined hereinbefore). However, it will be appreciated by those skilled in the chemical arts that this reaction sequence allows a broad selection of agents to be prepared.

The DEQAs herein can also contain a low level of fatty acid, which can be from unreacted Starting material used to form the DEQA and/or as a by-product of any partial degradation (hydrolysis) of the Softener active in the finished composition. It is preferred that the level of free fatty acid be low, preferably below about 15%, more preferably below about 10%, and even more preferably below about 2%, by weight of the Softener active.

### Other Softener Actives

The compositions can also contain other, usually supplementary, softener active(s), usually in minor amounts, typically from 0% to about 35%, preferably from about 1% to about 20%, more preferably from about 2% to about 10%, said other softener active being selected from:
(1) softener active having the formula:

[R₄₋ₘN⁽⁺⁾—R¹ₘ]A⁻
wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and where the Iodine Value (“IV”) of a fatty acid containing this R¹ group is from about 60 to about 140, (as used herein, the term “Iodine Value” means the Iodine Value of a “parent” fatty acid, or “corresponding” fatty acid, which is used to define a level of unsaturation for an R¹ group that is the same as the level of unsaturation that would be present in a fatty acid containing the same R¹ group) with, preferably, a cis/trans ratio of from about 1:1 to about 50:1, the minimum being 1:1, preferably from about 2:1 to about 40:1, more preferably from about 3:1 to about 30:1, and even more preferably from about 4:1 to about 20:1; each R¹ can also preferably be a branched chain C₁₄-C₂₂ alkyl group, preferably a branched chain C₁₆-C₁₈ group; each R is H or a short chain C₁-C₆, preferably C₁₋₃ alkyl or hydroxyalkyl group, e.g., methyl (most preferred), ethyl, propyl, hydroxyethyl, and the like, benzyl, or (R²O)₂₄H where each R² is a C₁₋₆ alkylene group; and A⁻ is a softener compatible anion, preferably, chloride, bromide, methylsulfate, ethylsulfate, sulfate, and nitrate, more preferably chloride and methyl sulfate;

Examples of Compound (1) are dialkylenedimethylammonium salts such as dicanoladimethylammonium chloride, dicanoladimethylammonium methylsulfate, di(partially hydrogenated soybean, cis/trans ratio of about 4:1)dimethylammonium chloride, dioleyldimethylammonium chloride. Dioleyldimethylammonium chloride and di(canola)dimethylammonium chloride are preferred.
(2) softener active having the formula:

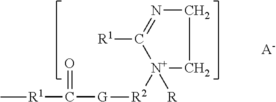

wherein each R, R¹, and A have the definitions given above; each R² is a C₁₋₆ alkylene group, preferably an ethylene group; and G is an oxygen atom or an —NR— group;

An example of Compound (2) is 1-methyl-1-oleylamidoethyl-2-oleylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion.
(3) softener having the formula:

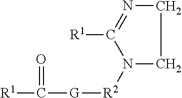

wherein R¹, R² and G are defined as above;

An example of Compound (3) is 1-oleylamidoethyl-2-oleylimidazoline wherein R¹ is an acyclic aliphatic C₁₅-C₇ hydrocarbon group, R² is an ethylene group, and G is a NH group.
(4) reaction products of substantially unsaturated and/or branched chain higher fatty acids with dialkylenetriamines in, e.g., a molecular ratio of about 2:1, said reaction products containing compounds of the formula:

R¹—C(O)—NH—R²—NH—R³—NH—C(O)—R¹
wherein R¹, R² are defined as above, and each R³ is a C₁₋₆ alkylene group, preferably an ethylene group;

An example of Compound (4) is reaction products of oleic acids with diethylenetriamine in a molecular ratio of about 2:1, said reaction product mixture containing N,N″-dioleoyldiethylenetriamine with the formula:

R¹—C(O)NH—CH₂CH₂—NH—CH₂CH₂—NH—C(O)R¹
wherein R¹—C(O) is oleoyl group.
(5) softener active having the formula:

[R¹—C(O)—NR—R²—N(R)₂—R³—NR—C(O)—R¹]A⁻
wherein R, R¹, R², R³ and A⁻ are defined as above;

An example of Compound (5) is a difatty amidoamine based softener having the formula:

[R¹—C(O)—NH—CH₂CH₂—N(CH₃)(CH₂CH₂OH)CH₂CH₂—NH—C(O)—R¹]⁺CH₃SO₄⁻
wherein R¹—C(O) is oleoyl group.
(6) the reaction product of substantially unsaturated and/or branched chain higher fatty acid with hydroxyalkylalkylenediamines in a molecular ratio of about 2:1, said reaction products containing compounds of the formula:

R¹—C(O)—NH—R²—N(R³OH)—C(O)—R¹
wherein R¹, R² and R³ are defined as above;

An example of Compound (6) is reaction products of oleic acids with N-2-hydroxyethylethylenediamine in a molecular ratio of about 2:1, said reaction product mixture containing a compound of the formula:

R¹C(O)—NH—CH₂CH₂—N(CH₂CH₂OH)—C(O)—R¹
Wherein R¹—C(O) is oleoyl group.
(7) softener having the formula:

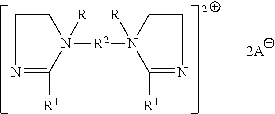

wherein R, R¹, R², and A⁻ are defined as above; and
mixtures thereof.

An example of Compound (7) is the diquaternary compound having the formula:

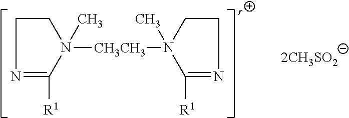

wherein R¹ is derived from oleic acid, and the compound is available from Witco Company.

Other optional but highly desirable cationic compounds which can be used in combination with the above softener actives are compounds containing one long chain acyclic C₈-C₂₂ hydrocarbon group, that are at least one of:
(8) acyclic quaternary ammonium salts having the formula:

[R¹—N(R⁵)₂—R⁶]_{+A}⁻
wherein R⁵ and R⁶ are C₁-C₄ alkyl or hydroxyalkyl groups, and R¹ and A⁻ are defined as herein above;
(9) substituted imidazolinium salts having the formula:

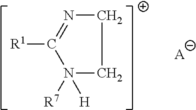

wherein R⁷ is hydrogen or a C₁-C₄ saturated alkyl or hydroxyalkyl group, and R¹ and A⁻ are defined as hereinabove;
(10) substituted imidazolinium salts having the formula:

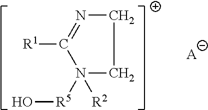

wherein R⁵ is a C₁-C₄ alkyl or hydroxyalkyl group, and R¹, R², and A⁻ are as defined above;
(11) alkylpyridinium salts having the formula:

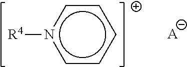

wherein R⁴ is an acyclic aliphatic C₉-C₂₂ hydrocarbon group and A⁻ is an anion; and

An example of Compound (11) is 1-ethyl-1-(2-hydroxyethyl)₂-isoheptadecylimidazolinium ethylsulfate wherein R¹ is a C₁₋₇ hydrocarbon group, R² is an ethylene group, R⁵ is an ethyl group, and A⁻ is an ethylsulfate anion.
(12) alkanamide alkylene pyridinium salts having the formula:

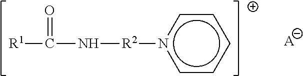

wherein R¹, R² and A⁻ are defined as herein above; and mixtures thereof.

Examples of Compound (8) are the monoalkenyltrimethylammonium salts such as monooleyltrimethylammonium chloride, monocanolatrimethylammonium chloride, and soyatrimethylammonium chloride. Monooleyltrimethylammonium chloride and monocanolatrimethylammonium chloride are preferred. Other examples of Compound (8) are soyatrimethylammonium chloride available from Witco Corporation under the trade name Adogen® 415, erucyltrimethylammonium chloride wherein R¹ is a C₂₂ hydrocarbon group derived from a natural source; soyadimethylethylammonium ethylsulfate wherein R¹ is a C₁₆-C₁₈ hydrocarbon group, R⁵ is a methyl group, R⁶ is an ethyl group, and A⁻ is an ethylsulfate anion; and methyl bis(2-hydroxyethyl)oleylammonium chloride wherein R¹ is a C₁₋₈ hydrocarbon group, R⁵ is a 2-hydroxyethyl group and R⁶ is a methyl group.

Additional softener actives that can be used herein are disclosed, at least generically for the basic structures, in U.S. Pat. Nos. 3,861,870; 4,308,151; 3,886,075; 4,233,164; 4,401,578; 3,974,076; and 4,237,016, all of said patents being incorporated herein by reference. The additional softener actives herein are preferably those that are highly unsaturated versions of the traditional softener actives, i.e., di-long chain alkyl nitrogen derivatives, normally cationic materials, such as dioleyldimethylammonium chloride and imidazolinium compounds as described hereinafter. Examples of more biodegradable softener actives can be found in U.S. Pat. Nos. 3,408,361; 4,709,045; 4,233,451; 4,127,489; 3,689,424; 4,128,485; 4,161,604; 4,189,593; and 4,339,391, said patents being incorporated herein by reference.

### Anion A

In the cationic nitrogenous Salts herein, the anion A, which is any Softener compatible anion, provides electrical neutrality. Most often, the anion used to provide electrical neutrality in these Salts is from a strong acid, especially a halide, Such as chloride, bromide, or iodide. However, other anions can be used, Such as methylsulfate, ethylsulfate, acetate, formate, Sulfate, carbonate, and the like. Chloride and methylsulfate are preferred herein as anion A.

### Iodine Value

The iodine value for fatty quaternary ammonium compounds is a measure of the unsaturation of the alkyl group or groups and is expressed in terms of g of iodine absorbed per 100 g of test sample (% iodine absorbed). It can be measured using AOCS Official Method Tg 3a-64 (Iodine Value of Fatty Quaternary Ammonium Chlorides).

For fatty acids that are used as starting materials to make fatty quaternary ammonium compounds, the iodine value is a measure of the unsaturation of fatty acids and is expressed in terms of the number of g of iodine absorbed per 100 g of test sample (% iodine absorbed). It can be measured using AOCS Official method Tg 1a-64 (Iodine Value of Fatty Acids, Wijs/Hanus).

Unsaturation occurs mainly as double bonds which are very reactive towards iodine, thus the higher the iodine value, the greater the level of unsaturation in the fat. The iodine value is an important quality parameter for oils and fats and has a direct impact on the processing, the shelf-life, and the suitable applications for fat-based products. Fatty quaternary ammonium compounds with higher IV values are easier to process and are a component of the present invention.

### Principal Solvent

The suitability of any principal solvent for the formulation of the liquid, concentrated, preferably clear, tissue softener compositions herein with the requisite stability is surprisingly selective. Suitable solvents can be selected based upon their octanol/water partition coefficient (P). Octanol/water partition coefficient of a principal solvent is the ratio between its equilibrium concentration in octanol and in water. The partition coefficients of the principal solvent ingredients of this invention are conveniently given in the form of their logarithm to the base 10, log P.

The log P of many ingredients has been reported; for example, the Pomona92 database, available from Daylight Chemical Information Systems, Inc. (Daylight CIS), Irvine, Calif., contains many, along with citations to the original literature. However, the log P values are most conveniently calculated by the “CLOGP” program, also available from Daylight CIS. This program also lists experimental log P values when they are available in the Pomona92 database. The “calculated log P” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each ingredient and takes into account the numbers and types of atoms, the atom connectivity, and chemical bonding. The ClogP values, which are the most reliable and widely used estimates for this physicochemical property, are preferably used instead of the experimental log P values in the selection of the principal solvent ingredients which are useful in the present invention. In embodiments of the invention principal solvents may have a ClogP of from about 2.0 to less than 15 or from about 0.64 to about 2.6.

Suitable solvents include:
I. mono-ols including:
a. n-propanol; and/or
b. 2-butanol and/or 2-methyl-2-propanol;
II. hexane diol isomers including: 2,3-butanediol, 2,3-dimethyl-; 1,2-butanediol, 2,3-dimethyl-; 1,2-butanediol, 3,3-dimethyl-; 2,3-pentanediol, 2-methyl-; 2,3-pentanediol, 3-methyl-; 2,3-pentanediol, 4-methyl-; 2,3-hexanediol; 3,4-hexanediol; 1,2-butanediol, 2-ethyl-; 1,2-pentanediol, 2-methyl-; 1,2-pentanediol, 3-methyl-; 1,2-pentanediol, 4-methyl-; and/or 1,2-hexanediol;
III. heptane diol isomers including: 1,3-propanediol, 2-butyl-; 1,3-propanediol, 2,2-diethyl-; 1,3-propanediol, 2-(1-methylpropyl)-; 1,3-propanediol, 2-(2-methylpropyl)-; 1,3-propanediol, 2-methyl-2-propyl-; 1,2-butanediol, 2,3,3-trimethyl-; 1,4-butanediol, 2-ethyl-2-methyl-; 1,4-butanediol, 2-ethyl-3-methyl-; 1,4-butanediol, 2-propyl-; 1,4-butanediol, 2-isopropyl-; 1,5-pentanediol, 2,2-dimethyl-; 1,5-pentanediol, 2,3-dimethyl-; 1,5-pentanediol, 2,4-dimethyl-; 1,5-pentanediol, 3,3-dimethyl-; 2,3-pentanediol, 2,3-dimethyl-; 2,3-pentanediol, 2,4-dimethyl-; 2,3-pentanediol, 3,4-dimethyl-; 2,3-pentanediol, 4,4-dimethyl-; 3,4-pentanediol, 2,3-dimethyl-; 1,5-pentanediol, 2-ethyl-; 1,6-hexanediol, 2-methyl-; 1,6-hexanediol, 3-methyl-; 2,3-hexanediol, 2-methyl-; 2,3-hexanediol, 3-methyl-; 2,3-hexanediol, 4-methyl-; 2,3-hexanediol, 5-methyl-; 3,4-hexanediol, 2-methyl-; 3,4-hexanediol, 3-methyl-; 1,3-heptanediol; 1,4-heptanediol; 1,5-heptanediol; and/or 1,6-heptanediol;
IV. octane diol isomers including: 1,3-propanediol, 2-(2-methylbutyl)-; 1,3-propanediol, 2-(1,1-dimethylpropyl)-1,3-propanediol, 2-(1,2-dimethylpropyl)-; 1,3-propanediol, 2-(1-ethylpropyl)-; 1,3-propanediol, 2-(1-methylbutyl)-; 1,3-propanediol, 2-(2,2-dimethylpropyl)-; 1,3-propanediol, 2-(3-methylbutyl)-; 1,3-propanediol, 2-butyl-2-methyl-; 1,3-propanediol, 2-ethyl-2-isopropyl-; 1,3-propanediol, 2-ethyl-2-propyl-; 1,3-propanediol, 2-methyl-2-(1-methylpropyl)-; 1,3-propanediol, 2-methyl-2-(2-methylpropyl)-; 1,3-propanediol, 2-tertiary-butyl-2-methyl-; 1,3-butanediol, 2,2-diethyl-; 1,3-butanediol, 2-(1-methylpropyl)-; 1,3-butanediol, 2-butyl-; 1,3-butanediol, 2-ethyl-2,3-dimethyl-; 1,3-butanediol, 2-(1,1-dimethylethyl)-; 1,3-butanediol, 2-(2-methylpropyl)-; 1,3-butanediol, 2-methyl-2-isopropyl-; 1,3-butanediol, 2-methyl-2-propyl-; 1,3-butanediol, 3-methyl-2-isopropyl-; 1,3-butanediol, 3-methyl-2-propyl-; 1,4-butanediol, 2,2-diethyl-; 1,4-butanediol, 2-methyl-2-propyl-; 1,4-butanediol, 2-(1-methylpropyl)-; 1,4-butanediol, 2-ethyl-2,3-dimethyl-; 1,4-butanediol, 2-ethyl-3,3-dimethyl-; 1,4-butanediol, 2-(1,1-dimethylethyl)-; 1,4-butanediol, 2-(2-methylpropyl)-; 1,4-butanediol, 2-methyl-3-propyl-; 1,4-butanediol, 3-methyl-2-isopropyl-; 1,3-pentanediol, 2,2,3-trimethyl-; 1,3-pentanediol, 2,2,4-trimethyl-; 1,3-pentanediol, 2,3,4-trimethyl-; 1,3-pentanediol, 2,4,4-trimethyl-; 1,3-pentanediol, 3,4,4-trimethyl-; 1,4-pentanediol, 2,2,3-trimethyl-; 1,4-pentanediol, 2,2,4-trimethyl-; 1,4-pentanediol, 2,3,3-trimethyl-; 1,4-pentanediol, 2,3,4-trimethyl-; 1,4-pentanediol, 3,3,4-trimethyl-; 1,5-pentanediol, 2,2,3-trimethyl-; 1,5-pentanediol, 2,2,4-trimethyl-; 1,5-pentanediol, 2,3,3-trimethyl-; 1,5-pentanediol, 2,3,4-trimethyl-; 2,4-pentanediol, 2,3,3-trimethyl-; 2,4-pentanediol, 2,3,4-trimethyl-; 1,3-pentanediol, 2-ethyl-2-methyl-; 1,3-pentanediol, 2-ethyl-3-methyl-; 1,3-pentanediol, 2-ethyl-4-methyl-; 1,3-pentanediol, 3-ethyl-2-methyl-; 1,4-pentanediol, 2-ethyl-2-methyl-; 1,4-pentanediol, 2-ethyl-3-methyl-; 1,4-pentanediol, 2-ethyl-4-methyl-; 1,4-pentanediol, 3-ethyl-2-methyl-; 1,4-pentanediol, 3-ethyl-3-methyl-; 1,5-pentanediol, 2-ethyl-2-methyl-; 1,5-pentanediol, 2-ethyl-3-methyl-; 1,5-pentanediol, 2-ethyl-4-methyl-; 1,5-pentanediol, 3-ethyl-3-methyl-; 2,4-pentanediol, 3-ethyl-2-methyl-; 1,3-pentanediol, 2-isopropyl-; 1,3-pentanediol, 2-propyl-; 1,4-pentanediol, 2-isopropyl-; 1,4-pentanediol, 2-propyl-; 1,4-pentanediol, 3-isopropyl-; 1,5-pentanediol, 2-isopropyl-; 2,4-pentanediol, 3-propyl-; 1,3-hexanediol, 2,2-dimethyl-; 1,3-hexanediol, 2,3-dimethyl-; 1,3-hexanediol, 2,4-dimethyl-; 1,3-hexanediol, 2,5-dimethyl-; 1,3-hexanediol, 3,4-dimethyl-; 1,3-hexanediol, 3,5-dimethyl-; 1,3-hexanediol, 4,5-dimethyl-; 1,4-hexanediol, 2,2-dimethyl-; 1,4-hexanediol, 2,3-dimethyl-; 1,4-hexanediol, 2,4-dimethyl-; 1,4-hexanediol, 2,5-dimethyl-; 1,4-hexanediol, 3,3-dimethyl-; 1,4-hexanediol, 3,4-dimethyl-; 1,4-hexanediol, 3,5-dimethyl-; 1,3-hexanediol, 4,4-dimethyl-; 1,4-hexanediol, 4,5-dimethyl-; 1,4-hexanediol, 5,5-dimethyl-; 1,5-hexanediol, 2,2-dimethyl-; 1,5-hexanediol, 2,3-dimethyl-; 1,5-hexanediol, 2,4-dimethyl-; 1,5-hexanediol, 2,5-dimethyl-; 1,5-hexanediol, 3,3-dimethyl-; 1,5-hexanediol, 3,4-dimethyl-; 1,5-hexanediol, 3,5-dimethyl-; 1,5-hexanediol, 4,5-dimethyl-; 1,6-hexanediol, 2,2-dimethyl-; 1,6-hexanediol, 2,3-dimethyl-; 1,6-hexanediol, 2,4-dimethyl-; 1,6-hexanediol, 2,5-dimethyl-; 1,6-hexanediol, 3,3-dimethyl-; 1,6-hexanediol, 3,4-dimethyl-; 2,4-hexanediol, 2,3-dimethyl-; 2,4-hexanediol, 2,4-dimethyl-; 2,4-hexanediol, 2,5-dimethyl-; 2,4-hexanediol, 3,3-dimethyl-; 2,4-hexanediol, 3,4-dimethyl-; 2,4-hexanediol, 3,5-dimethyl-; 2,4-hexanediol, 4,5-dimethyl-; 2,4-hexanediol, 5,5-dimethyl-; 2,5-hexanediol, 2,3-dimethyl-; 2,5-hexanediol, 2,4-dimethyl-; 2,5-hexanediol, 2,5-dimethyl-; 2,5-hexanediol, 3,3-dimethyl-; 2,5-hexanediol, 3,4-dimethyl-; 2,6-hexanediol, 3,3-dimethyl-; 1,3-hexanediol, 2-ethyl-; 1,3-hexanediol, 4-ethyl-; 1,4-hexanediol, 2-ethyl-; 1,4-hexanediol, 4-ethyl-; 1,5-hexanediol, 2-ethyl-; 2,4-hexanediol, 3-ethyl-; 2,4-hexanediol, 4-ethyl-; 2,5-hexanediol, 3-ethyl-; 1,3-heptanediol, 2-methyl-; 1,3-heptanediol, 3-methyl-; 1,3-heptanediol, 4-methyl-; 1,3-heptanediol, 5-methyl-; 1,3-heptanediol, 6-methyl-; 1,4-heptanediol, 2-methyl-; 1,4-heptanediol, 3-methyl-; 1,4-heptanediol, 4-methyl-; 1,4-heptanediol, 5-methyl-; 1,4-heptanediol, 6-methyl-; 1,5-heptanediol, 2-methyl-; 1,5-heptanediol, 3-methyl-; 1,5-heptanediol, 4-methyl-; 1,5-heptanediol, 5-methyl-; 1,5-heptanediol, 6-methyl-; 1,6-heptanediol, 2-methyl-; 1,6-heptanediol, 3-methyl-; 1,6-heptanediol, 4-methyl-; 1,6-heptanediol, 5-methyl-; 1,6-heptanediol, 6-methyl-; 2,4-heptanediol, 2-methyl-; 2,4-heptanediol, 3-methyl-; 2,4-heptanediol, 4-methyl-; 2,4-heptanediol, 5-methyl-; 2,4-heptanediol, 6-methyl-; 2,5-heptanediol, 2-methyl-; 2,5-heptanediol, 3-methyl-; 2,5-heptanediol, 4-methyl-; 2,5-heptanediol, 5-methyl-; 2,5-heptanediol, 6-methyl-; 2,6-heptanediol, 2-methyl-; 2,6-heptanediol, 3-methyl-; 2,6-heptanediol, 4-methyl-; 3,4-heptanediol, 3-methyl-; 3,5-heptanediol, 2-methyl-; 3,5-heptanediol, 3-methyl-; 3,5-heptanediol, 4-methyl-; 2,4-octanediol; 2,5-octanediol; 2,6-octanediol; 2,7-octanediol; 3,5-octanediol; and/or 3,6-octanediol;
V. nonane diol isomers including: 2,4-pentanediol, 2,3,3,4-tetramethyl-; 2,4-pentanediol, 3-tertiarybutyl-; 2,4-hexanediol, 2,5,5-trimethyl-; 2,4-hexanediol, 3,3,4-trimethyl-; 2,4-hexanediol, 3,3,5-trimethyl-; 2,4-hexanediol, 3,5,5-trimethyl-; 2,4-hexanediol, 4,5,5-trimethyl-; 2,5-hexanediol, 3,3,4-trimethyl-; and/or 2,5-hexanediol, 3,3,5-trimethyl-;
VI. glyceryl ethers and/or di(hydroxyalkyl)ethers including: 1,2-propanediol, 3-(n-pentyloxy)-; 1,2-propanediol, 3-(2-pentyloxy)-; 1,2-propanediol, 3-(3-pentyloxy)-; 1,2-propanediol, 3-(2-methyl-1-butyloxy)-; 1,2-propanediol, 3-(iso-amyloxy)-; 1,2-propanediol, 3-(3-methyl-2-butyloxy)-; 1,2-propanediol, 3-(cyclohexyloxy)-; 1,2-propanediol, 3-(1-cyclohex-1-enyloxy)-; 1,3-propanediol, 2-(pentyloxy)-; 1,3-propanediol, 2-(2-pentyloxy)-; 1,3-propanediol, 2-(3-pentyloxy)-; 1,3-propanediol, 2-(2-methyl-1-butyloxy)-; 1,3-propanediol, 2-(iso-amyloxy)-; 1,3-propanediol, 2-(3-methyl-2-butyloxy)-; 1,3-propanediol, 2-(cyclohexyloxy)-; 1,3-propanediol, 2-(1-cyclohex-1-enyloxy)-; 1,2-propanediol, 3-(butyloxy)-, triethoxylated; 1,2-propanediol, 3-(butyloxy)-, tetraethoxylated; 1,2-propanediol, 3-(butyloxy)-, pentaethoxylated; 1,2-propanediol, 3-(butyloxy)-, hexaethoxylated; 1,2-propanediol, 3-(butyloxy)-, heptaethoxylated; 1,2-propanediol, 3-(butyloxy)-, octaethoxylated; 1,2-propanediol, 3-(butyloxy)-, nonaethoxylated; 1,2-propanediol, 3-(butyloxy)-, monopropoxylated; 1,2-propanediol, 3-(butyloxy)-, dibutyleneoxylated; 1,2-propanediol, 3-(butyloxy)-, tributyleneoxylated; 1,2-propanediol, 3-phenyloxy-; 1,2-propanediol, 3-benzyloxy-; 1,2-propanediol, 3-(2-phenylethyloxy)-; 1,2-propanediol, 3-(1-phenyl-2-propanyloxy)-; 1,3-propanediol, 2-phenyloxy-; 1,3-propanediol, 2-(m-cresyloxy)-; 1,3-propanediol, 2-(p-cresyloxy)-; 1,3-propanediol, -benzyloxy-; 1,3-propanediol, 2-(2-phenylethyloxy)-; 1,3-propanediol, 2-(1-phenylethyloxy)-; bis(2-hydroxybutyl)ether; and/or bis(2-hydroxycyclopentyl)ether;
VII. saturated and unsaturated alicyclic diols and their derivatives including:
(a) the saturated diols and their derivatives, including:
1-isopropyl-1,2-cyclobutanediol; 3-ethyl-4-methyl-1,2-cyclobutanediol; 3-propyl-1,2-cyclobutanediol; 3-isopropyl-1,2-cyclobutanediol; 1-ethyl-1,2-cyclopentanediol; 1,2-dimethyl-1,2-cyclopentanediol; 1,4-dimethyl-1,2-cyclopentanediol; 2,4,5-trimethyl-1,3-cyclopentanediol; 3,3-dimethyl-1,2-cyclopentanediol; 3,4-dimethyl-1,2-cyclopentanediol; 3,5-dimethyl-1,2-cyclopentanediol; 3-ethyl-1,2-cyclopentanediol; 4,4-dimethyl-1,2-cyclopentanediol; 4-ethyl-1,2-cyclopentanediol; 1,1-bis(hydroxymethyl)cyclohexane; 1,2-bis(hydroxymethyl)cyclohexane; 1,2-dimethyl-1,3-cyclohexanediol; 1,3-bis(hydroxymethyl)cyclohexane; 1,3-dimethyl-1,3-cyclohexanediol; 1,6-dimethyl-1,3-cyclohexanediol; 1-hydroxy-cyclohexaneethanol; 1-hydroxy-cyclohexanemethanol; 1-ethyl-1,3-cyclohexanediol; 1-methyl-1,2-cyclohexanediol; 2,2-dimethyl-1,3-cyclohexanediol; 2,3-dimethyl-1,4-cyclohexanediol; 2,4-dimethyl-1,3-cyclohexanediol; 2,5-dimethyl-1,3-cyclohexanediol; 2,6-dimethyl-1,4-cyclohexanediol; 2-ethyl-1,3-cyclohexanediol; 2-hydroxycyclohexaneethanol; 2-hydroxyethyl-1-cyclohexanol; 2-hydroxymethylcyclohexanol; 3-hydroxyethyl-1-cyclohexanol; 3-hydroxycyclohexaneethanol; 3-hydroxymethylcyclohexanol; 3-methyl-1,2-cyclohexanediol; 4,4-dimethyl-1,3-cyclohexanediol; 4,5-dimethyl-1,3-cyclohexanediol; 4,6-dimethyl-1,3-cyclohexanediol; 4-ethyl-1,3-cyclohexanediol; 4-hydroxyethyl-1-cyclohexanol; 4-hydroxymethylcyclohexanol; 4-methyl-1,2-cyclohexanediol; 5,5-dimethyl-1,3-cyclohexanediol; 5-ethyl-1,3-cyclohexanediol; 1,2-cycloheptanediol; 2-methyl-1,3-cycloheptanediol; 2-methyl-1,4-cycloheptanediol; 4-methyl-1,3-cycloheptanediol; 5-methyl-1,3-cycloheptanediol; 5-methyl-1,4-cycloheptanediol; 6-methyl-1,4-cycloheptanediol; 1,3-cyclooctanediol; 1,4-cyclooctanediol; 1,5-cyclooctanediol; 1,2-cyclohexanediol, diethoxylate; 1,2-cyclohexanediol, triethoxylate; 1,2-cyclohexanediol, tetraethoxylate; 1,2-cyclohexanediol, pentaethoxylate; 1,2-cyclohexanediol, hexaethoxylate; 1,2-cyclohexanediol, heptaethoxylate; 1,2-cyclohexanediol, octaethoxylate; 1,2-cyclohexanediol, nonaethoxylate; 1,2-cyclohexanediol, monopropoxylate; 1,2-cyclohexanediol, monobutylenoxylate; 1,2-cyclohexanediol, dibutylenoxylate; and/or 1,2-cyclohexanediol, tributylenoxylate; and
(b). the unsaturated alicyclic diols including: 1,2-cyclobutanediol, 1-ethenyl-2-ethyl-; 3-cyclobutene-1,2-diol, 1,2,3,4-tetramethyl-; 3-cyclobutene-1,2-diol, 3,4-diethyl-; 3-cyclobutene-1,2-diol, 3-(1,1-dimethylethyl)-; 3-cyclobutene-1,2-diol, 3-butyl-; 1,2-cyclopentanediol, 1,2-dimethyl-4-methylene-; 1,2-cyclopentanediol, 1-ethyl-3-methylene-; 1,2-cyclopentanediol, 4-(1-propenyl); 3-cyclopentene-1,2-diol, 1-ethyl-3-methyl-; 1,2-cyclohexanediol, 1-ethenyl-; 1,2-cyclohexanediol, 1-methyl-3-methylene-; 1,2-cyclohexanediol, 1-methyl-4-methylene-; 1,2-cyclohexanediol, 3-ethenyl-; 1,2-cyclohexanediol, 4-ethenyl-; 3-cyclohexene-1,2-diol, 2,6-dimethyl-; 3-cyclohexene-1,2-diol, 6,6-dimethyl-; 4-cyclohexene-1,2-diol, 3,6-dimethyl-; 4-cyclohexene-1,2-diol, 4,5-dimethyl-; 3-cyclooctene-1,2-diol; 4-cyclooctene-1,2-diol; and/or 5-cyclooctene-1,2-diol;
VIII. Alkoxylated derivatives of C₃₋₈ diols. In the following disclosure, “EO” means polyethoxylates, i.e., —(CH₂CH₂O)ₙH; Me-Eₙ means methyl-capped polyethoxylates —(CH₂CH₂O)ₙCH₃; “2(Me-En)” means 2 Me-En groups needed; “PO” means polypropoxylates, —(CH(CH₃)CH₂O)ₙH; “BO” means polybutyleneoxy groups, (CH(CH₂CH₃)CH₂O)ₙH; and “n-BO” means poly(n-butyleneoxy) or poly(tetramethylene)oxy groups —(CH₂CH₂CH₂CH₂O)ₙH. The use of the term “(Cₓ)” herein refers to the number of carbon atoms in the base material which is alkoxylated. including:
1. 1,2-propanediol (C3) 2(Me-E₁₋₄); 1,2-propanediol (C3) PO₄; 1,2-propanediol, 2-methyl- (C4) (Me-E₄₋₁₀); 1,2-propanediol, 2-methyl- (C4) 2(Me-E₁); 1,2-propanediol, 2-methyl- (C4) PO₃; 1,2-propanediol, 2-methyl-(C4) BO₁; 1,3-propanediol (C3) 2(Me-E₆₋₈); 1,3-propanediol (C3) PO₅₋₆; 1,3-propanediol, 2,2-diethyl- (C7) E₁₋₇; 1,3-propanediol, 2,2-diethyl- (C7) PO₁; 1,3-propanediol, 2,2-diethyl- (C7) n-BO₁₋₂; 1,3-propanediol, 2,2-dimethyl- (C5) 2(Me E₁₋₂); 1,3-propanediol, 2,2-dimethyl- (C5) PO₃₋₄; 1,3-propanediol, 2-(1-methylpropyl)- (C7) E₁₋₇; 1,3-propanediol, 2-(1-methylpropyl)- (C7) POI; 1,3-propanediol, 2-(1-methylpropyl)- (C7) n-BO₁₋₂; 1,3-propanediol, 2-(2-methylpropyl)- (C7) E₁₋₇; 1,3-propanediol, 2-(2-methylpropyl)- (C7) PO₁; 1,3-propanediol, 2-(2-methylpropyl)-(C7) n-BO₁₋₂; 1,3-propanediol, 2-ethyl- (C5) (Me E₆₋₁₀); 1,3-propanediol, 2-ethyl-(C5) 2(Me E₁); 1,3-propanediol, 2-ethyl- (C5) PO₃; 1,3-propanediol, 2-ethyl-2-methyl- (C6) (Me E₁₋₆); 1,3-propanediol, 2-ethyl-2-methyl- (C6) PO₂; 1,3-propanediol, 2-ethyl-2-methyl- (C6) BO₁; 1,3-propanediol, 2-isopropyl- (C6) (Me E₁₋₆); 1,3-propanediol, 2-isopropyl- (C6) PO₂; 1,3-propanediol, 2-isopropyl- (C6) BO₁; 1,3-propanediol, 2-methyl- (C4) 2(Me E₂₋₅); 1,3-propanediol, 2-methyl- (C₄) PO₄₋₅; 1,3-propanediol, 2-methyl- (C4) BO₂; 1,3-propanediol, 2-methyl-2-isopropyl- (C7) E₂₋₉; 1,3-propanediol, 2-methyl-2-isopropyl- (C7) PO₁; 1,3-propanediol, 2-methyl-2-isopropyl- (C7) n-BO₁₋₃; 1,3-propanediol, 2-methyl-2-propyl- (C7) E₁₋₇; 1,3-propanediol, 2-methyl-2-propyl- (C7) PO₁; 1,3-propanediol, 2-methyl-2-propyl- (C7) n-BO₁₋₂; 1,3-propanediol, 2-propyl- (C6) (Me E₁₋₆); 1,3-propanediol, 2-propyl- (C6) PO₂; 1,3-propanediol, 2-propyl- (C6) BO₁.
2. 1,2-butanediol (C4) (Me E₂₋₈); 1,2-butanediol (C4) PO₂₋₃; 1,2-butanediol (C₄) BO₁; 1,2-butanediol, 2,3-dimethyl- (C6) E₁₋₆; 1,2-butanediol, 2,3-dimethyl- (C6) n-B₁₋₂; 1,2-butanediol, 2-ethyl- (C6) E₁₋₃; 1,2-butanediol, 2-ethyl- (C6) n-BO₁; 1,2-butanediol, 2-methyl- (C6) (Me E₁₋₂); 1,2-butanediol, 2-methyl- (C5) PO₁; 1,2-butanediol, 3,3-dimethyl- (C6) E₁₋₆; 1,2-butanediol, 3,3-dimethyl- (C6) n-BO₁₋₂; 1,2-butanediol, 3-methyl- (C5) (Me E₁₋₂); 1,2-butanediol 3-methyl- (C5) PO₁; 1,3-butanediol (C4) 2(Me E₃₋₆); 1,3-butanediol (C4) PO₅; 1,3-butanediol (C4) BO₂; 1,3-butanediol, 2,2,3-trimethyl- (C7) (Me E₁₋₃); 1,3-butanediol, 2,2,3-trimethyl- (C7) PO₁₋₂; 1,3-butanediol, 2,2-dimethyl- (C6) (Me E₃₋₈); 1,3-butanediol, 2,2-dimethyl- (C6) PO₃; 1,3-butanediol, 2,3-dimethyl- (C6) (Me E₃₋₈); 1,3-butanediol, 2,3-dimethyl- (C6) PO₃; 1,3-butanediol, 2-ethyl-(C6) (Me E₁₋₆); 1,3-butanediol, 2-ethyl- (C6) PO₂₋₃; 1,3-butanediol, 2-ethyl- (C₆) BO₁; 1,3-butanediol, 2-ethyl-2-methyl- (C7) (Me E₁); 1,3-butanediol, 2-ethyl-2-methyl-(C7) PO₁; 1,3-butanediol, 2-ethyl-2-methyl- (C7) n-BO₂₋₄; 1,3-butanediol, 2-ethyl-3-methyl- (C₇) (Me E₁); 1,3-butanediol, 2-ethyl-3-methyl- (C7) PO₁; 1,3-butanediol, 2-ethyl-3-methyl- (C7) n-BO₂₋₄; 1,3-butanediol, 2-isopropyl- (C₇) (Me E₁); 1,3-butanediol, 2-isopropyl- (C7) PO₁; 1,3-butanediol, 2-isopropyl- (C7) n-BO₂₋₄; 1,3-butanediol, 2-methyl- (C5) 2(Me E₁₋₃); 1,3-butanediol, 2-methyl-(C5) PO₄; 1,3-butanediol, 2-propyl- (C7) E₂₋₉; 1,3-butanediol, 2-propyl- (C₇) butanediol, 2-propyl- (C7) n-BO₁₋₃; 1,3-butanediol, 3-methyl- (C5) 2(Me E₁₋₃); 1,3-butanediol, 3-methyl- (C5) PO₄; 1,4-butanediol (C4) 2(Me E₂₋₄); 1,4-butanediol (C₄) PO₄₋₅; 1,4-butanediol (C4) BO₂; 1,4-butanediol, 2,2,3-(C7) E₂₋₉; 1,4-butanediol, 2,2,3-trimethyl- (C₇) PO₁; 1,4-butanediol, 2,2,3-trimethyl- (C7) n-BO₁₋₃; 1,4-butanediol, 2,2-dimethyl- (C6) (Me E1-6); 1,4-butanediol, 2,2-dimethyl- (C₆) PO₂; 1,4-butanediol, 2,2-dimethyl- (C6) BO₁; 1,4-butanediol, 2,3-dimethyl- (C6) (Me E₁₋₆); 1,4-butanediol, 2,3-dimethyl- (C6) PO₂; 1,4-butanediol, 2,3-dimethyl- (C6) BO₁; 1,4-butanediol, 2-ethyl- (C6) (Me E₁₋₄); 1,4-butanediol, 2-ethyl- (C6) PO₂; 1,4-butanediol, 2-ethyl-(C6) BO₁; 1,4-butanediol, 2-ethyl-2-methyl- (C7) E₁₋₇; 1,4-butanediol, 2-ethyl-2-methyl- (C7) PO₁; 1,4-butanediol, 2-ethyl-2-methyl- (C7) n-BO₁₋₂; 1,4-butanediol, 2-ethyl-3-methyl- (C7) E₁₋₇; 1,4-butanediol, 2-ethyl-3-methyl- (C7) PO₁; 1,4-butanediol, 2-ethyl-3-methyl- (C7) n-BO₁₋₂; 1,4-butanediol, 2-isopropyl- (C7) E₁₋₇; 1,4-butanediol, 2-isopropyl- (C7) PO₁; 1,4-butanediol, 2-isopropyl- (C7) n-BO₁₋₂; 1,4-butanediol, 2-methyl- (C5) (Me E₆₋₁₀); 1,4-butanediol, 2-methyl-(C5) 2(Me E₁); 1,4-butanediol, 2-methyl- (C5) PO₃; 1,4-butanediol, 2-methyl- (C5) BO₁; 1,4-butanediol, 2-propyl- (C7) E₁₋₅; 1,4-butanediol, 2-propyl- (C7) n-BO₁₋₂; 1,4-butanediol, 3-ethyl-1-methyl- (C₇) E₂₋₉; 1,4-butanediol, 3-ethyl-1-methyl- (C7) PO₁; 1,4-butanediol, 3-ethyl-1-methyl- (C7) n-BO₁₋₃; 2,3-butanediol (C4) (Me E₆₋₁₀); 2,3-butanediol (C4) 2(Me E₁); 2,3-butanediol (C4) PO₃₋₄; 2,3-butanediol (C4) BO₁; 2,3-butanediol, 2,3-dimethyl- (C6) E₃₋₉; 2,3-butanediol, 2,3-dimethyl- (C6) PO₁; 2,3-butanediol, 2,3-dimethyl- (C6) n-BO₁₋₃; 2,3-butanediol, 2-methyl- (C5) (Me E₁₋₅); 2,3-butanediol, 2-methyl- (C5) PO₂; 2,3-butanediol, 2-methyl- (C5).
3. 1,2-pentanediol (C5) E₃₋₁₀; 1,2-pentanediol, (C5) PO₁; 1,2-pentanediol, (C5) n-BO₂₋₃; 1,2-pentanediol, 2-methyl (C₆) E₁₋₃; 1,2-pentanediol, 2-methyl (C6) n-BO₁; 1,2-pentanediol, 2-methyl (C6) BO₁; 1,2-pentanediol, 3-methyl (C6) E₁₋₃; 1,2-pentanediol, 3-methyl (C6) n-BO₁; 1,2-pentanediol, 4-methyl (C6) E₁₋₃; 1,2-pentanediol, 4-methyl (C6) n-BO₁; 1,3-pentanediol (C5) 2(Me-E₁₋₂); 1,3-pentanediol (C5) PO₃₋₄; 1,3-pentanediol, 2,2-dimethyl- (C7) (Me-E₁); 1,3-pentanediol, 2,2-dimethyl- (C7) PO₁; 1,3-pentanediol, 2,2-dimethyl- (C7) n-BO₂₋₄; 1,3-pentanediol, 2,3-dimethyl- (C7) (Me-E₁); 1,3-pentanediol, 2,3-dimethyl- (C7) PO₁; 1,3-pentanediol, 2,3-dimethyl- (C7) n-BO₂₋₄; 1,3-pentanediol, 2,4-dimethyl-(C7) (Me-E₁); 1,3-pentanediol, 2,4-dimethyl- (C7) PO₁; 1,3-pentanediol, 2,4-dimethyl- (C7) n-BO₂₋₄; 1,3-pentanediol, 2-ethyl- (C7) E₂₋₉; 1,3-pentanediol, 2-ethyl- (C₇) PO₁; 1,3-pentanediol, 2-ethyl- (C7) n-BO₁₋₃; 1,3-pentanediol, 2-methyl-(C6) 2(Me-E₁₋₆); 1,3-pentanediol, 2-methyl- (C6) PO₂₋₃; 1,3-pentanediol, 2-methyl- (C₆) BO₁; 1,3-pentanediol, 3,4-dimethyl- (C7) (Me-E₁); 1,3-pentanediol, 3,4-dimethyl- (C7) PO₁; 1,3-pentanediol, 3,4-dimethyl- (C7) n-BO₂₋₄; 1,3-pentanediol, 3-methyl-(C6) (Me-E₁₋₆); 1,3-pentanediol, 3-methyl- (C6) PO₂₋₃; 1,3-pentanediol, 3-methyl- (C6) BO₁; 1,3-pentanediol, 4,4-dimethyl- (C7) (Me-E₁); 1,3-pentanediol, 4,4-dimethyl- (C7) PO₁; 1,3-pentanediol, 4,4-dimethyl- (C7) n-BO₂₋₄; 1,3-pentanediol, 4-methyl- (C6) (Me-E₁₋₆); 1,3-pentanediol, 4-methyl- (C6) PO₂₋₃; 1,3-pentanediol, 4-methyl- (C6) BO₁; 1,4-pentanediol, (C5) 2(Me-E₁₋₂); 1,4-pentanediol (C5) PO₃₋₄; 1,4-pentanediol, 2,2-dimethyl- (C7) (Me-E₁); 1,4-pentanediol, 2,2-dimethyl- (C7) PO₁; 1,4-pentanediol, 2,2-dimethyl- (C7) n-BO₂₋₄; 1,4-pentanediol, 2,3-dimethyl- (C7) (Me-E₁); 1,4-pentanediol, 2,3-dimethyl- (C7) PO₁; 1,4-pentanediol, 2,3-dimethyl- (C7) n-BO₂₋₄; 1,4-pentanediol, 2,4-dimethyl-(C7) (Me-E₁); 1,4-pentanediol, 2,4-dimethyl- (C7) PO₁; 1,4-pentanediol, 2,4-dimethyl- (C7) n-BO₂₋₄; 1,4-pentanediol, 2-methyl- (C6) (Me-E₁₋₆); 1,4-pentanediol, 2-methyl- (C6) PO₂₋₃; 1,4-pentanediol, 2-methyl- (C₆) BO₁; 1,4-pentanediol, 3,3-dimethyl- (C7) (Me-E₁); 1,4-pentanediol, 3,3-dimethyl-(C7) PO₁; 1,4-pentanediol, 3,3-dimethyl- (C7) n-BO₂₋₄; 1,4-pentanediol, 3,4-dimethyl- (C7) (Me-E₁); 1,4-pentanediol, 3,4-dimethyl- (C7) PO₁; 1,4-pentanediol, 3,4-dimethyl-(C7) n-BO₂₋₄; 1,4-pentanediol, 3-methyl- (C6) 2(Me-E₁₋₆); 1,4-pentanediol, 2-methyl- (C6) PO₂₋₃; 1,4-pentanediol, 3-methyl- (C₆) BO₁; 1,4-pentanediol, 4-methyl- (C6) 2Me-E₁₋₆); 1,4-pentanediol, 4-methyl- (C6) PO₂₋₃; 1,4-pentanediol, 4-methyl- (C₆) BO₁; 1,5-pentanediol, (C5) (Me-E₄₋₁₀); 1,5-pentanediol (C5) 2(Me-E₁); 1,5-pentanediol (C5) PO₃; 1,5-pentanediol, 2,2-dimethyl- (C7) E₁₋₇; 1,5-pentanediol, 2,2-dimethyl- (C7) PO₁; 1,5-pentanediol, 2,2-dimethyl- (C7) n-BO₁₋₂; 1,5-pentanediol, 2,3-dimethyl- (C7) E₁₋₇; 1,5-pentanediol, 2,3-dimethyl- (C7) PO₁; 1,5-pentanediol, 2,3-dimethyl- (C7) n-BO₁₋₂; 1,5-pentanediol, 2,4-dimethyl- (C7) E₁₋₇; 1,5-pentanediol, 2,4-dimethyl- (C7) PO₁; 1,5-pentanediol, 2,4-dimethyl- (C7) n-B₁₋₂; 1,5-pentanediol, 2-ethyl- (C7) E₁₋₅; 1,5-pentanediol, 2-ethyl- (C7) n-BO₁₋₂; 1,5-pentanediol, 2-methyl- (C6) (Me-E₁₋₄); 1,5-pentanediol, 2-methyl-(C6) PO₂; 1,5-pentanediol, 3,3-dimethyl- (C7) E₁₋₇; 1,5-pentanediol, 3,3-dimethyl-(C7) PO₁; 1,5-pentanediol, 3,3-dimethyl- (C7) n-BO₁₋₂; 1,5-pentanediol, 3-methyl- (C6) (Me-E₁₋₄); 1,5-pentanediol, 3-methyl- (C6) PO₂; 2,3-pentanediol, (C5) (Me-E₁₋₃) 2,3-pentanediol, (C5) PO₂; 2,3-pentanediol, 2-methyl- (C6) E₁₋₇; 2,3-pentanediol, 2-methyl- (C6) PO₁; 2,3-pentanediol, 2-methyl- (C6) n-BO₁₋₂; 2,3-pentanediol, 3-methyl- (C6) E₁₋₇; 2,3-pentanediol, 3-methyl- (C6) PO₁; 2,3-pentanediol, 3-methyl-(C6) n-BO₁₋₂; 2,3-pentanediol, 4-methyl- (C6) E₁₋₇; 2,3-pentanediol, 4-methyl-(C6) PO₁; 2,3-pentanediol, 4-methyl- (C6) n-BO-₁₋₂; 2,4-pentanediol, (C5) 2(Me-E₁₋₄); 2,4-pentanediol (C5) PO₄; 2,4-pentanediol, 2,3-dimethyl- (C7) (Me-E₁₋₄); 2,4-pentanediol, 2,3-dimethyl- (C7) PO₂; 2,4-pentanediol, 2,4-dimethyl- (C7) (Me-E₁₋₄); 2,4-pentanediol, 2,4-dimethyl- (C7) PO₂; 2,4-pentanediol, 2-methyl- (C7) (Me-E₅₋₁₀); 2,4-pentanediol, 2-methyl- (C7) PO₃; 2,4-pentanediol, 3,3-dimethyl- (C7) (Me-E₁₋₄); 2,4-pentanediol, 3,3-dimethyl- (C7) PO₂; 2,4-pentanediol, 3-methyl- (C6) (Me-E₅₋₁₀); 2,4-pentanediol, 3-methyl-(C6) PO₃.
4. 1,3-hexanediol (C6) (Me-E₁₋₅); 1,3-hexanediol (C6) PO₂; 1,3-hexanediol (C6) BO₁; 1,3-hexanediol, 2-methyl- (C7) E₂₋₉; 1,3-hexanediol, 2-methyl- (C₇) PO₁; 1,3-hexanediol, 2-methyl-(C7) n-BO₁₋₃; 1,3-hexanediol, 2-methyl- (C7) BO₁; 1,3-hexanediol, 3-methyl- (C7) E₂₋₉; 1,3-hexanediol, 3-methyl-(C₇) PO₁; 1,3-hexanediol, 3-methyl- (C7) n-BO₁₋₃; 1,3-hexanediol, 4-methyl- (C7) E₂₋₉; 1,3-hexanediol, 4-methyl- (C7) PO₁; 1,3-hexanediol, 4-methyl- (C7) n-BO₁₋₃; 1,3-hexanediol, 5-methyl- (C7) E₂₋₉; 1,3-hexanediol, 5-methyl- (C₇) PO₁; 1,3-hexanediol, 5-methyl- (C7) n-BO₁₋₃; 1,4-hexanediol (C6) (Me-E₁₋₅); 1,4-hexanediol (C6) PO₂; 1,4-hexanediol (C6) BO₁; 1,4-hexanediol, 2-methyl- (C7) E₂₋₉; 1,4-hexanediol, 2-methyl- (C₇) PO₁; 1,4-hexanediol, 2-methyl- (C7) n-BO₁₋₃; 1,4-hexanediol, 3-methyl- (C7) E₂₋₉; 1,4-hexanediol, 3-methyl- (C₇) PO₁; 1,4-hexanediol, 3-methyl- (C7) n-BO₁₋₃; 1,4-hexanediol, 4-methyl- (C7) E₂₋₉; 1,4-hexanediol, 4-methyl- (C7) PO₁; 1,4-hexanediol, 4-methyl- (C7) n-BO₁₋₃; 1,4-hexanediol, 5-methyl- (C7) E₂₋₉; 1,4-hexanediol, 5-methyl- (C₇) PO₁; 1,4-hexanediol, 5-methyl- (C7) n-BO₁₋₃; 1,5-hexanediol (C6) (Me-E₁₋₅); 1,5-hexanediol (C6) PO₂; 1,5-hexanediol (C6) BO₁; 1,5-hexanediol, 2-methyl- (C7) E₂₋₉; 1,5-hexanediol, 2-methyl- (C₇) PO₁; 1,5-hexanediol, 2-methyl-(C7) n-BO₁₋₃; 1,5-hexanediol, 3-methyl- (C7) E₂₋₉; 1,5-hexanediol, 3-methyl- (C7) PO₁; 1,5-hexanediol, 3-methyl- (C7) n-BO₁₋₃; 1,5-hexanediol, 4-methyl- (C7) E₂₋₉; 1,5-hexanediol, 4-methyl- (C₇) PO₁; 1,5-hexanediol, 4-methyl- (C7) n-BO₁₋₃; 1,5-hexanediol, 5-methyl- (C7) E₂₋₉; 1,5-hexanediol, 5-methyl- (C₇) PO₁; 1,5-hexanediol, 5-methyl- (C7) n-BO₁₋₃; 1,6-hexanediol (C6) (Me-E₁₋₂); 1,6-hexanediol (C6) PO₁₋₂; 1,6-hexanediol (C6) n-BO₄; 1,6-hexanediol, 2-methyl- (C7) E₁₋₅; 1,6-hexanediol, 2-methyl- (C7) n-BO₁₋₂; 1,6-hexanediol, 3-methyl- (C7) E₁₋₅; 1,6-hexanediol, 3-methyl- (C7) n-BO₁₋₂; 2,3-hexanediol (C6) E₁₋₅; 2,3-hexanediol (C6) n-BO₁; 2,3-hexanediol (C6) BO₁; 2,4-hexanediol (C6) (Me-E₃₋₈); 2,4-hexanediol (C6) PO₃; 2,4-hexanediol, 2-methyl- (C7) (Me-E₁₋₂); 2,4-hexanediol 2-methyl- (C7) PO₁₋₂; 2,4-hexanediol, 3-methyl- (C7) (Me-E₁₋₂); 2,4-hexanediol 3-methyl- (C7) PO₁₋₂; 2,4-hexanediol, 4-methyl- (C7) (Me-E₁₋₂); 2,4-hexanediol 4-methyl- (C7) PO₁₋₂; 2,4-hexanediol, 5-methyl- (C7) (Me-E₁₋₂); 2,4-hexanediol 5-methyl- (C7) PO₁₋₂; 2,5-hexanediol (C6) (Me-E₃₋₈); 2,5-hexanediol (C6) PO₃; 2,5-hexanediol, 2-methyl- (C7) (Me-E₁₋₂); 2,5-hexanediol 2-methyl- (C7) PO₁₋₂; 2,5-hexanediol, 3-methyl- (C7) (Me-E₁₋₂); 2,5-hexanediol 3-methyl- (C7) PO₁₋₂; 3,4-hexanediol (C6) EO₁₋₅; 3,4-hexanediol (C6) n-BO₁; 3,4-hexanediol (C6) BO₁.
5. 1,3-heptanediol (C7) E₁₋₇; 1,3-heptanediol (C7) PO₁; 1,3-heptanediol (C7) n-BO₁₋₂; 1,4-heptanediol (C7) E₁₋₇; 1,4-heptanediol (C7) PO₁; 1,4-heptanediol (C7) n-BO₁₋₂; 1,5-heptanediol (C7) E₁₋₇; 1,5-heptanediol (C7) PO₁; 1,5-heptanediol (C7) n-BO₁₋₂; 1,6-heptanediol (C7) E₁₋₇; 1,6-heptanediol (C7) PO₁; 1,6-heptanediol (C7) n-BO₁₋₂; 1,7-heptanediol (C7) E₁₋₂; 1,7-heptanediol (C7) n-BO₁; 2,4-heptanediol (C7) E₃₋₁₀; 2,4-heptanediol (C7) (Me-E₁); 2,4-heptanediol (C7) PO₁; 2,4-heptanediol (C7) n-BO₃; 2,5-heptanediol (C7) E₃₋₁₀; 2,5-heptanediol (C7) (Me-E₁); 2,5-heptanediol (C7) PO₁; 2,5-heptanediol (C7) n-BO₃; 2,6-heptanediol (C7) E₃₋₁₀; 2,6-heptanediol (C7) (Me-E₁); 2,6-heptanediol (C7) PO₁; 2,6-heptanediol (C7) n-BO₃; 3,5-heptanediol (C7) E₃₋₁₀; 3,5-heptanediol (C7) (Me-E₁); 3,5-heptanediol (C7) PO₁; 3,5-heptanediol (C7) n-BO₃.
6. 1,3-butanediol, 3-methyl-2-isopropyl- (C8) PO₁; 2,4-pentanediol, 2,3,3-trimethyl- (C8) PO₁; 1,3-butanediol, 2,2-diethyl- (C8) E₂₋₅; 2,4-hexanediol, 2,3-dimethyl- (C8) E₂₋₅; 2,4-hexanediol, 2,4-dimethyl- (C8) E₂₋₅; 2,4-hexanediol, 2,5-dimethyl- (C8) E₂₋₅; 2,4-hexanediol, 3,3-dimethyl-(C8) E₂₋₅; 2,4-hexanediol, 3,4-dimethyl- (C8) E₂₋₅; 2,4-hexanediol, 3,5-dimethyl- (C8) E₂₋₅; 2,4-hexanediol, 4,5-dimethyl- (C8) E₂₋₅; 2,4-hexanediol, 5,5-dimethyl- (C8) E₂₋₅; 2,5-hexanediol, 2,3-dimethyl- (C8) E₂₋₅; 2,5-hexanediol, 2,4-dimethyl- (C8) E₂₋₅; 2,5-hexanediol, 2,5-dimethyl- (C8) E₂₋₅; 2,5-hexanediol, 3,3-dimethyl- (C8) E₂₋₅; 2,5-hexanediol, 3,4-dimethyl- (C8) E₂₋₅; 3,5-heptanediol, 3-methyl- (C8) E₂₋₅; 1,3-butanediol, diethyl- (C₈) n-BO₁₋₂; 2,4-hexanediol, 2,3-dimethyl- (C8) n-BO₁₋₂; 2,4-hexanediol, 2,4-dimethyl- (C8) n-BO₁₋₂; 2,4-hexanediol, 2,5-dimethyl- (C8) n-BO₁₋₂; 2,4-hexanediol, 3,3-dimethyl- (C8) n-BO₁₋₂; 2,4-hexanediol, 3,4-dimethyl-(C8) n-BO₁₋₂; 2,4-hexanediol, 3,5-dimethyl- (C8) n-BO₁₋₂; 2,4-hexanediol, 4,5-dimethyl- (C8) n-BO₁₋₂; 2,4-hexanediol, 5,5-dimethyl-, n-BO₁₋₂; 2,5-hexanediol, 2,3-dimethyl-(C8) n-BO₁₋₂; 2,5-hexanediol, 2,4-dimethyl- (C8) n-BO₁₋₂; 2,5-hexanediol, 2,5-dimethyl- (C8) n-BO₁₋₂; 2,5-hexanediol, 3,3-dimethyl- (C8) n-BO₁₋₂; 2,5-hexanediol, 3,4-dimethyl- (C8) n-BO₁₋₂; 3,5-heptanediol, 3-methyl-(C8) n-BO₁₋₂; 1,3-propanediol, 2-(1,2-dimethylpropyl)- (C8) n-BO₁; 1,3-butanediol, 2-ethyl-2,3-dimethyl- (C8) n-BO₁; 1,3-butanediol, 2-methyl-2-isopropyl- (C8) n-BO₁; 1,4-butanediol, 3-methyl-2-isopropyl- (C8) n-BO₁; 1,3-pentanediol, 2,2,3-trimethyl- (C8) n-BO₁; 1,3-pentanediol, 2,2,4-trimethyl- (C8) n-BO₁; 1,3-pentanediol, 2,4,4-trimethyl- (C8) n-BO₁; 1,3-pentanediol, 3,4,4-trimethyl- (C8) n-BO₁; 1,4-pentanediol, 2,2,3-trimethyl- (C8) n-BO₁; 1,4-pentanediol, 2,2,4-trimethyl- (C8) n-BO₁; 1,4-pentanediol, 2,3,3-trimethyl- (C8) n-BO₁; 1,4-pentanediol, 2,3,4-trimethyl- (C8) n-BO₁; 1,4-pentanediol, 3,3,4-trimethyl- (C8) n-BO₁; 2,4-pentanediol, 2,3,4-trimethyl- (C8) n-BO₁; 2,4-hexanediol, 4-ethyl- (C8) n-BO₁; 2,4-heptanediol, 2-methyl- (C8) n-BO₁; 2,4-heptanediol, 3-methyl- (C8) n-BO₁; 2,4-heptanediol, 4-methyl- (C8) n-BO₁; 2,4-heptanediol, 5-methyl- (C8) n-BO₁; 2,4-heptanediol, 6-methyl- (C8) n-BO₁; 2,5-heptanediol, 2-methyl- (C8) n-BO₁; 2,5-heptanediol, 3-methyl- (C8) n-BO₁; 2,5-heptanediol, 4-methyl- (C8) n-BO₁; 2,5-heptanediol, 5-methyl- (C8) n-BO₁; 2,5-heptanediol, 6-methyl- (C8) n-BO₁; 2,6-heptanediol, 2-methyl- (C8) n-BO₁; 2,6-heptanediol, 3-methyl- (C8) n-BO₁; 2,6-heptanediol, 4-methyl- (C8) n-BO₁; 3,5-heptanediol, 2-methyl- (C8) n-BO₁; 1,3-propanediol, 2-(1,2-dimethylpropyl)- (C8) E₁₋₃; 1,3-butanediol, 2-ethyl-2,3-dimethyl- (C8) E₁₋₃; 1,3-butanediol, 2-methyl-2-isopropyl- (C8) E₁₋₃; 1,4-butanediol, 3-methyl-2-isopropyl- (C8) E₁₋₃; 1,3-pentanediol, 2,2,3-trimethyl- (C8) E₁₋₃; 1,3-pentanediol, 2,2,4-trimethyl- (C8) E₁₋₃; 1,3-pentanediol, 2,4,4-trimethyl- (C8) E₁₋₃; 1,3-pentanediol, 3,4,4-trimethyl- (C8) E₁₋₃; 1,4-pentanediol, 2,2,3-trimethyl- (C8) E₁₋₃; 1,4-pentanediol, 2,2,4-trimethyl- (C8) E₁₋₃; 1,4-pentanediol, 2,3,3-trimethyl- (C8) E₁₋₃; 1,4-pentanediol, 2,3,4-trimethyl- (C8) E₁₋₃; 1,4-pentanediol, 3,3,4-trimethyl- (C8) E₁₋₃; 2,4-pentanediol, 2,3,4-trimethyl- (C8) E₁₋₃; 2,4-hexanediol, 4-ethyl- (C8) E₁₋₃; 2,4-heptanediol, 2-methyl- (C8) E₁₋₃; 2,4-heptanediol, 3-methyl-(C8) E₁₋₃; 2,4-heptanediol, 4-methyl- (C8) E₁₋₃; 2,4-heptanediol, 5-methyl- (C8) E₁₋₃; 2,4-heptanediol, 6-methyl- (C8) E₁₋₃; 2,5-heptanediol, 2-methyl- (C8) E₁₋₃; 2,5-heptanediol, 3-methyl- (C8) E₁₋₃; 2,5-heptanediol, 4-methyl- (C8) E₁₋₃; 2,5-heptanediol, 5-methyl- (C8) E₁₋₃; 2,5-heptanediol, 6-methyl- (C8) E₁₋₃; 2,6-heptanediol, 2-methyl- (C8) E₁₋₃; 2,6-heptanediol, 3-methyl- (C8) E₁₋₃; 2,6-heptanediol, 4-methyl- (C8) E₁₋₃; and/or 3,5-heptanediol, 2-methyl- (C8) E₁₋₃; and
mixtures thereof.
IX. aromatic diols including: 1-phenyl-1,2-ethanediol; 1-phenyl-1,2-propanediol; 2-phenyl-1,2-propanediol; 3-phenyl-1,2-propanediol; 1-(3-methylphenyl)- 1,3-propanediol; 1-(4-methylphenyl)- 1,3-propanediol; 2-methyl-1-phenyl-1,3-propanediol; 1-phenyl-1,3-butanediol; 3-phenyl- 1,3-butanediol; 1-phenyl-1,4-butanediol; 2-phenyl-1,4-butanediol; and/or 1-phenyl-2,3-butanediol.
X. principal solvents which are homologs, or analogs, of the above structures where one, or more, CH₂ groups are added while, for each CH₂ group added, two hydrogen atoms are removed from adjacent carbon atoms in the molecule to form one carbon-carbon double bond, thus holding the number of hydrogen atoms in the molecule constant, including the following:
1,3-Propanediol, 2,2-di-2-propenyl-; 1,3-Propanediol, 2-(1-pentenyl)-; 1,3-Propanediol, 2-(2-methyl-2-propenyl)-2-(2-propenyl)-; 1,3-Propanediol, 2-(3-methyl-1-butenyl)-; 1,3-Propanediol, 2-(4-pentenyl)-; 1,3-Propanediol, 2-ethyl-2-(2-methyl-2-propenyl)-; 1,3-Propanediol, 2-ethyl-2-(2-propenyl)-; 1,3-Propanediol, 2-methyl-2-(3-methyl-3-butenyl)-; 1,3-Butanediol, 2,2-diallyl-; 1,3-Butanediol, 2-(1-ethyl-1-propenyl)-; 1,3-Butanediol, 2-(2-butenyl)-2-methyl-; 1,3-Butanediol, 2-(3-methyl-2-butenyl)-; 1,3-Butanediol, 2-ethyl-2-(2-propenyl)-; 1,3-Butanediol, 2-methyl-2-(1-methyl-2-propenyl)-; 1,4-Butanediol, 2,3-bis(1-methylethylidene)-; 1,4-Butanediol, 2-(3-methyl-2-butenyl)-3-methylene-; 2-Butene-1,4-diol, 2-(1,1-dimethylpropyl)-; 2-Butene-1,4-diol, 2-(1-methylpropyl)-; 2-Butene-1,4-diol, 2-butyl-; 1,3-Pentanediol, 2-ethenyl-3-ethyl-; 1,3-Pentanediol, 2-ethenyl-4,4-dimethyl-1,4-Pentanediol, 3-methyl-2-(2-propenyl)-; 1,5-Pentanediol, 2-(1-propenyl)-; 1,5-Pentanediol, 2-(2-propenyl)-; 1,5-Pentanediol, 2-ethylidene-3-methyl-; 1,5-Pentanediol, 2-propylidene-; 2,4-Pentanediol, 3-ethylidene-2,4-dimethyl-; 4-Pentene-1,3-diol, 2-(1,1-dimethylethyl)-; 4-Pentene- 1,3-diol, 2-ethyl-2,3-dimethyl-; 1,4-Hexanediol, 4-ethyl-2-methylene-; 1,5-Hexadiene-3,4-diol, 2,3,5-trimethyl-; 1,5-Hexadiene-3,4-diol, 5-ethyl-3-methyl-; 1,5-Hexanediol, 2-(1-methylethenyl)-; 1,6-Hexanediol, 2-ethenyl-; 1-Hexene-3,4-diol, 5,5-dimethyl-; 1-Hexene-3,4-diol, 5,5-dimethyl-; 2-Hexene-1,5-diol, 4-ethenyl-2,5-dimethyl-; 3-Hexene-1,6-diol, 2-ethenyl-2,5-dimethyl-; 3-Hexene-1,6-diol, 2-ethyl-; 3-Hexene-1,6-diol, 3,4-dimethyl-; 4-Hexene-2,3-diol, 2,5-dimethyl-; 4-Hexene-2,3-diol, 3,4-dimethyl-; 5-Hexene-1,3-diol, 3-(2-propenyl)-; 5-Hexene-2,3-diol, 2,3-dimethyl-; 5-Hexene-2,3-diol, 3,4-dimethyl-; 5-Hexene-2,3-diol, 3,5-dimethyl-; 5-Hexene-2,4-diol, 3-ethenyl-2,5-dimethyl-; 1,4-Heptanediol, 6-methyl-5-methylene-; 1,5-Heptadiene-3,4-diol, 2,3-dimethyl-; 1,5-Heptadiene-3,4-diol, 2,5-dimethyl-; 1,5-Heptadiene-3,4-diol, 3,5-dimethyl-; 1,7-Heptanediol, 2,6-bis(methylene)-; 1,7-Heptanediol, 4-methylene-; 1-Heptene-3,5-diol, 2,4-dimethyl-; 1-Heptene-3,5-diol, 2,6-dimethyl-; 1-Heptene-3,5-diol, 3-ethenyl-5-methyl; 1-Heptene-3,5-diol, 6,6-dimethyl-; 2,4-Heptadiene-2,6-diol, 4,6-dimethyl-; 2,5-Heptadiene-1,7-diol, 4,4-dimethyl-; 2,6-Heptadiene-1,4-diol, 2,5,5-trimethyl-; 2-Heptene-1,4-diol, 5,6-dimethyl-; 2-Heptene-1,5-diol, 5-ethyl-; 2-Heptene-1,7-diol, 2-methyl-; 3-Heptene-1,5-diol, 4,6-dimethyl-; 3-Heptene-1,7-diol, 3-methyl-6-methylene-; 3-Heptene-2,5-diol, 2,4-dimethyl-; 3-Heptene-2,5-diol, 2,5-dimethyl-; 3-Heptene-2,6-diol, 2,6-dimethyl-; 3-Heptene-2,6-diol, 4,6-dimethyl-; 5-Heptene-1,3-diol, 2,4-dimethyl-; 5-Heptene-1,3-diol, 3,6-dimethyl-; 5-Heptene-1,4-diol, 2,6-dimethyl-; 5-Heptene-1,4-diol, 3,6-dimethyl-; 5-Heptene-2,4-diol, 2,3-dimethyl-; 6-Heptene-1,3-diol, 2,2-dimethyl-; 6-Heptene-1,4-diol, 4-(2-propenyl)-; 6-Heptene-1,4-diol, 5,6-dimethyl-; 6-Heptene-1,5-diol, 2,4-dimethyl-; 6-Heptene-1,5-diol, 2-ethylidene-6-methyl-; 6-Heptene-2,4-diol, 4-(2-propenyl)-; 6-Heptene-2,4-diol, 5,5-dimethyl-; 6-Heptene-2,5-diol, 4,6-dimethyl-; 6-Heptene-2,5-diol, 5-ethenyl-4-methyl-; 1,3-Octanediol, 2-methylene-; 1,6-Octadiene-3,5-diol, 2,6-dimethyl-; 1,6-Octadiene-3,5-diol, 3,7-dimethyl-; 1,7-Octadiene-3,6-diol, 2,6-dimethyl-; 1,7-Octadiene-3,6-diol, 2,7-dimethyl-; 1,7-Octadiene-3,6-diol, 3,6-dimethyl-; 1-Octene-3,6-diol, 3-ethenyl-; 2,4,6-Octatriene-1,8-diol, 2,7-dimethyl-; 2,4-Octadiene-1,7-diol, 3,7-dimethyl-; 2,5-Octadiene-1,7-diol, 2,6-dimethyl-; 2,5-Octadiene-1,7-diol, 3,7-dimethyl-; 2,6-Octadiene-1,4-diol, 3,7-dimethyl- (Rosiridol); 2,6-Octadiene-1,8-diol, 2-methyl-; 2,7-Octadiene-1,4-diol, 3,7-dimethyl-; 2,7-Octadiene-1,5-diol, 2,6-dimethyl-; 2,7-Octadiene-1,6-diol, 2,6-dimethyl- (8-Hydroxylinalool); 2,7-Octadiene-1,6-diol, 2,7-dimethyl-; 2-Octene-1,4-diol; 2-Octene-1,7-diol; 2-Octene-1,7-diol, 2-methyl-6-methylene-; 3,5-Octadiene-1,7-diol, 3,7-dimethyl-; 3,5-Octadiene-2,7-diol, 2,7-dimethyl-; 3,5-Octanediol, 4-methylene-; 3,7-Octadiene-1,6-diol, 2,6-dimethyl-; 3,7-Octadiene-2,5-diol, 2,7-dimethyl-; 3,7-Octadiene-2,6-diol, 2,6-dimethyl-; 3-Octene-1,5-diol, 4-methyl-; 3-Octene-1,5-diol, 5-methyl-; 4,6-Octadiene-1,3-diol, 2,2-dimethyl-; 4,7-Octadiene-2,3-diol, 2,6-dimethyl-; 4,7-Octadiene-2,6-diol, 2,6-dimethyl-; 4-Octene-1,6-diol, 7-methyl-; 2,7-bis(methylene)-; 2-methylene-; 5,7-Octadiene-1,4-diol, 2,7-dimethyl-; 5,7-Octadiene-1,4-diol, 7-methyl-; 5-Octene-1,3-diol; 6-Octene-1,3-diol, 7-methyl-; 6-Octene-1,4-diol, 7-methyl-; 6-Octene-1,5-diol; 6-Octene-1,5-diol, 7-methyl-; 6-Octene-3,5-diol, 2-methyl-; 6-Octene-3,5-diol, 4-methyl-; 7-Octene-1,3-diol, 2-methyl-; 7-Octene-1,3-diol, 4-methyl-; 7-Octene-1,3-diol, 7-methyl-; 7-Octene-1,5-diol; 7-Octene-1,6-diol; 7-Octene-1,6-diol, 5-methyl-; 7-Octene-2,4-diol, 2-methyl-6-methylene-; 7-Octene-2,5-diol, 7-methyl-; 7-Octene-3,5-diol, 2-methyl-; 1-Nonene-3,5-diol; 1-Nonene-3,7-diol; 3-Nonene-2,5-diol; 4,6-Nonadiene-1,3-diol, 8-methyl-; 4-Nonene-2,8-diol; 6,8-Nonadiene-1,5-diol; 7-Nonene-2,4-diol; 8-Nonene-2,4-diol; 8-Nonene-2,5-diol; 1,9-Decadiene-3,8-diol; and/or 1,9-Decadiene-4,6-diol; and
XI. mixtures thereof.

The solvents are desirably kept to the lowest levels that are feasible in the present compositions for obtaining translucency or clarity and creating non-shear aqueous emulsions. The presence of water exerts an important effect on the need for the solvents to achieve desired properties of these softening compositions. The higher the water content, the higher the principal solvent level is needed to attain emulsion non-shear sensitive behavior and clarity. Inversely, the less the water content, the less principal solvent is needed. To maintain non-shear sensitive behavior and clarity, the solvent to water ratio by weight may be from about 0.6 to about 12, from about 0.7 to about 8, from about 0.9 to about 6, or from about 0.9 to about 3.

The softening active to solvent weight ratios may be from about 8 to about 1, from about 6 to about 1, from about 4 to about 1, and from about 0.4 to about 1. When the solvent to water ratio or softening active to solvent ratios are outside these ranges, a shear sensitive material is formed

“Sanitary tissue product”, which may be referred to herein as a “web”, as used herein means a soft, low density (i.e. < about 0.15 g/cm³) article comprising a web comprising one or more fibrous structure plies according to the present invention, wherein the sanitary tissue product is useful as a wiping implement for post-urinary and post-bowel movement cleaning (toilet tissue), for otorhinolaryngological discharges (facial tissue), and multi-functional absorbent and cleaning uses (absorbent towels).

In embodiments, the sanitary tissue product may be a toilet tissue product (toilet tissue), for example a toilet tissue product that is designed to be flushed down toilets, for example residential toilets, such as tank-type toilets, and to disperse within municipal sewer systems and/or septic systems/tanks. Such a toilet tissue product is void of permanent wet strength and/or levels of permanent wet strength agents, for example polyaminoamide-epichlorohydrin (PAE), which would negatively impact the toilet tissue's decay such that the toilet tissue would exhibit a wet strength decay of 25% or less, more typically a wet strength decay of only about 10-15% during a 30 minute soak test. Such a wet strength decay of 25% or less (typically 10-15%) is unacceptable and undesirable for toilet tissue, which is designed to be flushed down toilets and into septic systems/tanks and/or municipal sewer systems. However, the toilet tissue may comprise a temporary wet strength agent such that the toilet tissue exhibits enough wet strength (temporary wet strength) to meet consumer requirements (doesn't fall apart and/or disperse and/or leak through) during use, for example during the brief time the toilet tissue is wet during use and/or exposed to a relatively small amount of water (not saturated) by a consumer (during wiping, for example after urinating), without causing the toilet tissue to exhibit flushability issues compared to the flushability issues a toilet tissue exhibiting permanent wet strength would encounter. In embodiments, the toilet tissue of the present invention exhibits a wet strength decay of greater than 60% during a 30 minute soak test (and typically even a wet strength decay of at least 40-60% after 2 minutes during the 30 minute soak test), which is considered “temporary wet strength”, due to the concerns of flushability issues. Temporary wet strength in paper, for example toilet issue, is achieved by adding temporary wet strength agents, for example glyoxylated polyacrylamide, to the toilet tissue.

In another example, the sanitary tissue product is a paper towel product (paper towel), for example a paper towel product designed to absorb fluids, such as water, while still remaining intact (not dispersing). Paper towel products are designed to not be flushed down toilets and/or to not disperse when wet. Such a paper towel product comprises permanent wet strength and/or levels of permanent wet strength agents, for example polyaminoamide-epichlorohydrin (PAE), which result in the paper towel's exhibiting a wet strength decay of 25% or less, more typically a wet strength decay of only about 10-15% during a 30 minute soak test.

Toilet tissue that exhibits temporary wet strength when disposed in a toilet due to the toilet bowl's water begins decaying, breaking apart into pieces, and dispersing upon saturation of the toilet tissue. Paper towels, which exhibit permanent wet strength, are not suitable to be flushed in toilets because unlike toilet tissue, which exhibits temporary wet strength, paper towels will not decay, break apart into pieces, and disperse upon saturation of the paper towel resulting in the toilet being clogged and/or pipes, septic tank, and municipal sewer systems being “clogged” by the intact paper towel. One reason paper towels require permanent wet strength is that consumers may reuse and rewet a paper towel during use. As a result of the issues associated with having permanent wet strength in toilet tissue (bath tissue), one of ordinary skill in the art understands that all bath tissue grades should never include a level of permanent wet strength agent that would result in the toilet tissue (bath tissue) exhibiting permanent wet strength and thus resulting in flushability issues, such as issues with dispersing and/or very low wet strength decay properties.

The sanitary tissue products of the present invention may exhibit a basis weight of greater than 15 g/m² to about 120 g/m² and/or from about 15 g/m² to about 110 g/m² and/or from about 20 g/m² to about 100 g/m² and/or from about 30 to 90 g/m² as measured according to the respective Basis Weight Test Method described herein. In addition, the sanitary tissue products and/or fibrous structures of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m² as measured according to the respective Basis Weight Test Method described herein.

The sanitary tissue products, for example toilet tissue products, of the present invention may exhibit a sum of MD and CD dry tensile strength of greater than about 59 g/cm (150 g/in) and/or from about 78 g/cm to about 394 g/cm and/or from about 98 g/cm to about 335 g/cm as measured according to the respective Dry Tensile Strength Test Method described herein. In addition, the sanitary tissue products, for example toilet tissue products, of the present invention may exhibit a sum of MD and CD dry tensile strength of greater than about 196 g/cm and/or from about 196 g/cm to about 394 g/cm and/or from about 216 g/cm to about 335 g/cm and/or from about 236 g/cm to about 315 g/cm as measured according to the respective Dry Tensile Strength Test Method described herein. In embodiments, the sanitary tissue products, for example toilet tissue products, of the present invention exhibit a sum of MD and CD dry tensile strength of less than about 394 g/cm and/or less than about 335 g/cm as measured according to the respective Dry Tensile Strength Test Method described herein.

In another example, the sanitary tissue products, for example paper towel products, of the present invention may exhibit a sum of MD and CD dry tensile strength of greater than about 196 g/cm and/or greater than about 236 g/cm and/or greater than about 276 g/cm and/or greater than about 315 g/cm and/or greater than about 354 g/cm and/or greater than about 394 g/cm and/or from about 315 g/cm to about 1968 g/cm and/or from about 354 g/cm to about 1181 g/cm and/or from about 354 g/cm to about 984 g/cm and/or from about 394 g/cm to about 787 g/cm as measured according to the respective Dry Tensile Strength Test Method described herein.

The sanitary tissue products, for example toilet tissue products, of the present invention may exhibit an initial sum of MD and CD wet tensile strength of less than about 78 g/cm and/or less than about 59 g/cm and/or less than about 39 g/cm and/or less than about 29 g/cm as measured according to the Wet Tensile Test Method described herein.

The sanitary tissue products, for example paper towel products, of the present invention may exhibit an initial sum of MD and CD wet tensile strength of greater than about 118 g/cm and/or greater than about 157 g/cm and/or greater than about 196 g/cm and/or greater than about 236 g/cm and/or greater than about 276 g/cm and/or greater than about 315 g/cm and/or greater than about 354 g/cm and/or greater than about 394 g/cm and/or from about 118 g/cm to about 1968 g/cm and/or from about 157 g/cm to about 1181 g/cm and/or from about 196 g/cm to about 984 g/cm and/or from about 196 g/cm to about 787 g/cm and/or from about 196 g/cm to about 591 g/cm as measured according to the Wet Tensile Test Method described herein.

The sanitary tissue products of the present invention may exhibit a density (based on measuring caliper at 95 g/in²), which may be referred to as a sheet density or web density to distinguish it from the sanitary tissue product roll's Roll Density, of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may comprise additives such as surface softening agents, for example quaternary ammonium compounds, temporary wet strength agents, permanent wet strength agents, wetting agents, latexes, especially surface-pattern-applied latexes, dry strength agents such as carboxymethylcellulose and starch, and other types of additives suitable for inclusion in and/or on sanitary tissue products.

In embodiments, the sanitary tissue products, for example paper towel products, of the present invention exhibits permanent wet strength, for example the sanitary tissue products comprise a permanent wet strength agent, such as a level of permanent wet strength agent such that the sanitary tissue products exhibit a wet strength decay of less than 25% and/or less than 20% and/or less than 15% and/or from about 5% to about 25% and/or from about 5% to about 20% and/or from about 10% to about 15% during a 30 minute soak test.

In embodiments, the sanitary tissue products, for example toilet tissue products, of the present invention are void of permanent wet strength, for example the sanitary tissue products exhibit a wet strength decay of greater than 60% and/or greater than 65% and/or greater than 70% and/or greater than 75% and/or greater than 80% during a 30 minute soak test and/or greater than 40% and/or greater than 45% and/or greater than 50% and/or greater than 55% and/or greater than 60% after 2 minutes during the 30 minute soak test. In embodiments, the sanitary tissue products, for example toilet tissue products, comprise a temporary wet strength agent, for example a level of temporary wet strength agent, such that the sanitary tissue products exhibit the wet strength decay described immediately above.

“Web” and/or “fibrous structure” and/or “fibrous structure ply” as used herein means a structure that comprises a plurality of pulp fibers. In embodiments, the fibrous structure may comprise a plurality of wood pulp fibers. In another example, the fibrous structure may comprise a plurality of non-wood pulp fibers, for example plant fibers, synthetic staple fibers, and mixtures thereof. In still another example, in addition to pulp fibers, the fibrous structure may comprise a plurality of filaments, such as polymeric filaments, for example thermoplastic filaments such as polyolefin filaments (i.e., polypropylene filaments) and/or hydroxyl polymer filaments, for example polyvinyl alcohol filaments and/or polysaccharide filaments such as starch filaments. In embodiments, a fibrous structure according to the present invention means an orderly arrangement of fibers alone and with filaments within a structure in order to perform a function. Non-limiting examples of fibrous structures of the present invention include paper.

Non-limiting examples of processes for making fibrous structures include known wet-laid papermaking processes, for example conventional wet-pressed papermaking processes and through-air-dried papermaking processes, and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire, tissue, or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, often referred to as a parent roll, and may subsequently be converted into a finished product, e.g. a single- or multi-ply sanitary tissue product.

The fibrous structures of the present invention may be homogeneous or may be layered. If layered, the fibrous structures may comprise at least two and/or at least three and/or at least four and/or at least five layers of fiber and/or filament compositions. In embodiments, the fibrous structure of the present invention comprises fibers, for example pulp fibers, such as cellulosic pulp fibers and more particularly wood pulp fibers, such as 100% of the fibers present in the fibrous structure are pulp fibers, such as cellulosic pulp fibers and more particularly wood pulp fibers. In another example, the fibrous structure of the present invention comprises fibers and is void of filaments. In still further embodiments, the fibrous structures of the present invention comprise filaments and fibers, such as a co-formed fibrous structure.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In embodiments, a co-formed fibrous structure comprises solid additives, such as fibers, such as wood pulp fibers, and filaments, such as polypropylene filaments. “Fiber” and/or “Filament” as used herein means an elongate particulate having an apparent length greatly exceeding its apparent width, i.e. a length to diameter ratio of at least about 10. In embodiments, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include pulp fibers, such as wood pulp fibers, and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In embodiments of the present invention, “fiber” refers to papermaking fibers. Papermaking fibers useful in the present invention include cellulosic fibers commonly known as wood pulp fibers.

Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified fibrous structure. U.S. Pat. Nos. 4,300,981 and 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In embodiments, the wood pulp fibers are selected from the group consisting of hardwood pulp fibers, softwood pulp fibers, and mixtures thereof. The hardwood pulp fibers may be selected from the group consisting of: tropical hardwood pulp fibers, northern hardwood pulp fibers, and mixtures thereof. The tropical hardwood pulp fibers may be at least one of eucalyptus fibers, acacia fibers, or mixtures thereof. The northern hardwood pulp fibers may be at least one of cedar fibers, maple fibers, or mixtures thereof.

In addition to the various wood pulp fibers, other cellulosic fibers such as cotton linters, rayon, lyocell, trichomes, seed hairs, and bagasse can be used in this invention. Other sources of cellulose in the form of fibers or capable of being spun into fibers include grasses and grain sources.

“Trichome” or “trichome fiber” as used herein means an epidermal attachment of a varying shape, structure and/or function of a non-seed portion of a plant. In embodiments, a trichome is an outgrowth of the epidermis of a non-seed portion of a plant. The outgrowth may extend from an epidermal cell. In one embodiment, the outgrowth is a trichome fiber. The outgrowth may be a hairlike or bristlelike outgrowth from the epidermis of a plant.

Trichome fibers are different from seed hair fibers in that they are not attached to seed portions of a plant. For example, trichome fibers, unlike seed hair fibers, are not attached to a seed or a seed pod epidermis. Cotton, kapok, milkweed, and coconut coir are non-limiting examples of seed hair fibers.

Further, trichome fibers are different from nonwood bast and/or core fibers in that they are not attached to the bast, also known as phloem, or the core, also known as xylem portions of a nonwood dicotyledonous plant stem. Non-limiting examples of plants which have been used to yield nonwood bast fibers and/or nonwood core fibers include kenaf, jute, flax, ramie and hemp.

Further trichome fibers are different from monocotyledonous plant derived fibers such as those derived from cereal straws (wheat, rye, barley, oat, etc.), stalks (corn, cotton, sorghum, Hesperaloe funifera, etc.), canes (bamboo, bagasse, etc.), grasses (esparto, lemon, sabai, switchgrass, etc), since such monocotyledonous plant derived fibers are not attached to an epidermis of a plant.

Further, trichome fibers are different from leaf fibers in that they do not originate from within the leaf structure. Sisal and abaca are sometimes liberated as leaf fibers.

Finally, trichome fibers are different from wood pulp fibers since wood pulp fibers are not outgrowths from the epidermis of a plant; namely, a tree. Wood pulp fibers rather originate from the secondary xylem portion of the tree stem.

### Test Methods

### Shear Rheology Method

Objective: The Shear Rheology Method uses a rotational rheometer with a Couette geometry to measure the shear viscosity of an emulsion over a shear range from 1 to 1000 s⁻¹. A power-law fluid model is then fitted to determine the emulsion's power law index η.

### Procedure:

A suitable apparatus for this method is a controlled-stress rotational rheometer capable of maintaining a sample temperature of 25.0±0.1° C., an example of which is the Discovery HR-2 rheometer outfitted with temperature controller available from TA Instruments, New Castle, Delaware, USA, or equivalent. The rheometer is outfitted with Couette “concentric cylinders” tooling with a stainless-steel cup (30 mm diameter by 78 mm depth, such as TA part 545696.901, or equivalent) and stainless-steel rotor (28 mm diameter by 42 mm height, such as TA part 546012.901, or equivalent).

A small volume (50-100 mL) of the emulsion to be tested, is held at a temperature of 24±2° C. for at least 4 hours prior to measurement. With the rheometer tooling held at 25.0° C., 24±1.5 mL of emulsion is poured into the stainless-steel rheometer cup. The upper rotor is lowered to an operating gap of 5919.2 um and a two-piece cup cover is positioned on top of the sample cup around the shaft of the rotor. The sample is conditioned at 25.0° C. for at least 60 seconds until a steady temperature 25.0±0.1° C. is achieved and subsequently held at 25.0±0.1° C. for the entire method. Viscosity is measured using a shear-rate sweep from 1 s⁻¹ to 1000 s⁻¹ collecting five points per decade distributed logarithmically over the range. Specifically, the steady-state viscosity η is measured at the following shear rates \dot{γ}: 1.00, 1.58, 2.51, 3.98, 6.31, 10.00, 15.85, 25.12, 39.81, 63.10, 100.00, 158.49, 251.19, 398.11, 630.96, and 1000.00 s⁻¹.

Analysis: The data is fitted to a power-law model η=k\dot{γ}ⁿ⁻¹, where k is the consistency index and n is the power law index. This may be done, for example, by plotting the log of viscosity as a function of the log of shear rate and using linear least squares to fit a straight line through all points. The slope of the resulting line is n−1. The power law index is a dimensionless quantity and is reported to the nearest 0.001.

### Quat Titration Method

Objective: The Quat Titration Method is applicable to the determination of the percent activity of the cationic quaternary compounds found in Di(Alkylcarboxyethyl)-hydroxyethyl-methylammonium methyl sulfate emulsion over the formulation range as a quality control check for the material.

### Procedure:

Prepare Dimidium Bromide-Disulfine Blue indicator solution (CTL Scientific Supply Corp #191892H, 1016-3 Grand Blvd, Deer Park, NY 11729, ph. 631-242-4249 or equivalent) according to the manufacturer directions. Start by transferring 40 mL of dimidium bromide-disulfine blue indicator solution to a 1000 mL volumetric flask. Add approximately 500 mL of distilled water to the flask. Then transfer 40 mL of 5N sulfuric acid (VWR BDH7648-1 or equivalent) and transfer it to the volumetric flask. Upon addition of the acid, the solution will change from a blue-green color to yellow. Dilute the solution with distilled water to one liter and mix well. If desired, transfer the indicator to a bottle and keep capped while not in use. Discard any unused mixed indicator after 6 months.

Prepare a 0.004N Sodium Dodecylsulfate (SDS) solution. Using an analytical balance, weigh out 1.1535 g of SDS (Ultra pure >99%, VWR 4095-04 or equivalent)±0.001 g and transfer to a 1000 mL volumetric flask. Add distilled water to volume (gently and slowly to avoid bubbles) and mix until the SDS is completely dissolved. Transfer the SDS solution to a capped bottle for storage. Solution is stable for at least 6 months and store at room temperature.

Prepare a sample for titration by weighing between 0.04 and 0.10 g (2-4 drops) of Di(Alkylcarboxyethyl)-hydroxyethyl-methylammonium methyl sulfate emulsion into a tall form titration cylinder. Record the mass of the emulsion sample to the nearest 0.1 mg. If the emulsion is hot, cool to room temperature before weighing. Add a stir bar to the titration cylinder. Working in a hood, add 30 mL of dichloromethane (DCM) (VWR 9315-02 or equivalent) and stir on a magnetic stir plate for 10-15 seconds to incorporate. Turn off the stir plate and add 30 mL of the dimidium bromide-disulphine blue indicator solution to the titration cylinder. Resume stirring the sample. During this step, the quaternary compound will complex with the indicator forming a blue colored complex in the DCM layer. The titration is a two-phase titration where the organic DCM layer is on the bottom of the titration cylinder and the water indicator layer is at the top when the layers are allowed to separate. Titrate the sample with 0.004N SDS solution. Add increments of the SDS solution and rapidly stir for 60 seconds or longer between additions. Turn off the magnetic stirrer, allow the layers to separate, and check the intensity of the blue color against a white background. As the titration progresses the color in the DCM layer will change from dark blue to light blue to a faint blue gray before reaching the endpoint at the appearance of the first tinge of pink color. When the blue color starts to become lighter, add the titrant in 0.1 to 0.3 mL increments and stir again for at least 60 seconds. When the color becomes a very faint blue gray, add the titrant drop wise between stirrings until the endpoint has been reached at the first tinge of pink color in the DCM layer. Di(Alkylcarboxyethyl)-hydroxyethyl-methylammonium methyl sulfateDi(Alkylcarboxyethyl)-hydroxyethyl-methylammonium methyl sulfate emulsion tends to emulsify the DCM and indicator layers. Allow the layers to fully separate between SDS additions and stirring. When the endpoint has been reached, stir again and allow to separate and verify the endpoint holds. If a deep pink or red color appears in the DCM layer, the sample was over titrated, and the analysis must be started over. To avoid over-titrating the sample, increase the stirring time between titrant additions. Record the volume of titrant used to reach the endpoint to the nearest 0.05 mL if read from a glass burette, or to the nearest 0.01 mL as displayed on a digital burette.

### Data Analysis:

Calculate the percent active quat in the dispersion using the following calculation and report results to the nearest 0.1% active:

$$\frac{SDS titrant volume ( mL )}{Emulsion Sample mass ( g )} \times 0.308 = \% Active in Emulsion$$

The conversion factor for the quat in the current Di(Alkylcarboxyethyl)-hydroxyethyl-methylammonium methyl sulfateDi(Alkylcarboxyethyl)-hydroxyethyl-methylammonium methyl sulfate Emulsion formulation with an average molecular weight of 770 g/mol is 0.308.

$$\frac{mL SDS}{g Sample} \times \frac{1 L}{1000 mL} \times \frac{0.0 \; 04 mol SDS}{1 L} \times \frac{1 mol Quat}{1 mol SDS} \times \frac{770 g Quat}{mol} \times 100 \% = 0.308$$

### Turbidity Method

This method measures the turbidity used to assess clarity and raw material quality of softening compositions disclosed herein. by measuring the amount of light scattered by particles suspended in a fluid sample.

### Equipment:

### 1. Hach 2100P Turbidimeter

a. The method is based upon a comparison of the intensity of light scattered by the sample under defined conditions with the intensity of light scattered by a standard reference suspension. The higher the intensity of scattered light, the higher the turbidity.
b. Note that the most common measurement for turbidity is the Nephelometric Turbidity Units (NTU).

### Temperature of Sample—25° C.±2° C.

### Chemicals and Accessories:

1. 20, 100 and 800 NTU StabCal calibration standards
2. StabCal 10 NTU verification standard
3. Sample Glass Vials

### Procedure:

1. Obtain sample to be tested and allow it to come to room temperature before analysis.
2. Fill a clean vial (supplied in the turbidity kit) with the sample.
3. Ensure the bottom of the vial is completely clean, dry, and scratch free
4. Power on turbidity meter by pressing the power button
5. Place vial into turbidity meter and close lid.
6. Push the “Read” button and wait a few seconds.
7. Record the result displayed on the screen
8. Turn off instrument when testing is complete.

NOTE: Any air bubbles, dust, or other floating particles will yield a reading that is higher than the true turbidity of the sample. If sample is viscous and has air bubbles, centrifuge the sample for several seconds to quickly remove any air bubbles. Do not centrifuge longer than a few seconds, as it may settle out other particles that may contribute to the true turbidity.

### Water Activity Method

The purpose of this procedure is to measure the Water Activity (% Relative Humidity) of a particular product, raw material or finished product intermediate. This assessment provides information on the hostility of a raw material or formulation to inhibit microbial growth and/or material quality. The details of the method are described in United States Pharmacopeia (U) 922 and USP 1112 (water activity of nonsterile pharmaceutical products)

Rotronic Hydrolab 3 and Rotronic Sample Cups (PS-40 deep) and (PS-14 shallow) (Rotronic Instrument Corp, 160 E. Main St., Huntington, NY 11743)

Measure water activity in a temperature stable area. Set the instrument in AwQuick mode. To do this press MENU, use arrows to scroll until mode is displayed, press ENTER to select. Once selected QAwQuick should appear on the display, if it does not use arrows to scroll and select it from the options. Pressing ENTER again brings dwell time up on display; the recommended dwell time is 4 minutes, if a different time is displayed reset to four minutes. Enter twice to return to original display.

### Sample Preparation

Allow for sufficient time for the samples to equilibrate to the temperature of the probe by placing samples still in their original packaging close to the environment experienced by the probe. Prior to measurement, quickly fill the sample cup with the product to be measured as full as possible (at least ¾th of the cup). Use the deep sample cups for products in the bulk such as capsules and tablets and shallow sample cups products in powder form such as raw materials or blends. Prior to measurement, quickly fill the sample cup with the product to be measured as full as possible (at least ¾th of the cup). To avoid exposure to ambient conditions samples need to be dispensed into sample cups as quickly as possible and to avoid the sample touching the probe do not fill the cup above the fill line. The lid of the cup should be closed until just before placing the sample into the probe.

### Measurement

Set the instrument in AwQuick mode. Visually inspect the O-ring of the probe to ensure that is completely intact and flexible.

When ready to measure: Remove lid from sample cup and quickly place in any available probe base. Return probe cover and ensure no gaps are present between base and cover. Press the ENTER key on the keypad, after 60 seconds the trend indicator appears for temperature. Two arrows mean stable signal. When the projected value of Aw (Water Activity) is stable, the Hygrolab beeps once and freezes the display. Black rectangles to the left of the display indicate that the measurement has ended.

The AwQuick mode runs simultaneously for all probes attached. When a probe has finished measuring, the Hygrolab beeps once and freezes the display for that probe. The display can be manually switched to another probe from the keypad using the UP or DOWN arrows. When the last probe has completed measuring, record results and press the ENTER key to clear the digital display.

### Results

The results are displayed in Aw units (Water Activity). If required, the values can be converted to Relative Humidity (% RH) using the following equation:

% RH=100×Aw

For materials requiring this test that have a maximum allowable Water Activity. The sample will be considered to have passed if the measured Water Activity (in Aw or RH units) is lower than the upper limit set forth in the specification for that material. The sample will be considered to have failed if the measured Water Activity is higher than or equal to the upper limit set forth in the specification for that material.

### EXAMPLES

TABLE 1
Tissue softener compositions.

| | Inv | Inv | Inv | Inv | Inv | Com | Com | Com | Com | Com | Com | Com |
|---|---|---|---|---|---|---|---|---|---|---|---|---|
| | Sam- | Sam- | Sam- | Sam- | Sam- | Sam- | Sam- | Sam- | Sam- | Sam- | Sam- | Sam- |
| | ple | ple | ple | ple | ple | ple | ple | ple | ple | ple | ple | ple |
| Ingre- | 1 | 2 | 3 | 4 | 5 | 1 and 2 | 5 | 6 | 7 | 8 | 3 | 4 |
| dient | Wt % | Wt % | Wt % | Wt % | Wt % | Wt % | Wt % | Wt % | Wt % | Wt % | Wt % | Wt % |
| TEA- | 80 | 80 | 53.33 | 53.33 | 53.33 | — | 53.33 | 53.33 | 80 | 80 | | |
| Diester | | | | | | | | | | | | |
| Quat* | | | | | | | | | | | | |
| (IV~80) | | | | | | | | | | | | |
| DMEA- | — | — | — | — | — | 53.6 | — | — | — | — | 85.71 | |
| Diester | | | | | | | | | | | | |
| Quat^{&} | | | | | | | | | | | | |
| (IV~56) | | | | | | | | | | | | |
| TEA- | — | — | — | — | — | — | — | — | — | — | | 75 |
| Diester | | | | | | | | | | | | |
| Quat^{#} | | | | | | | | | | | | |
| (IV~42) | | | | | | | | | | | | |
| 1,2- | 9.5 | — | 22.17 | — | — | — | — | — | — | — | | |
| hexane- | | | | | | | | | | | | |
| diol | | | | | | | | | | | | |
| TMPD^{$} | — | 9.5 | — | 22.17 | 39.67 | — | — | — | — | — | 9.5 | 9.5 |
| Glycerol | — | — | — | — | — | — | — | — | 9.5 | — | — | — |
| 1,3- | — | — | — | — | — | — | — | — | — | 9.5 | — | — |
| butane- | | | | | | | | | | | | |
| diol | | | | | | | | | | | | |
| Process | — | — | — | — | — | 2.28 | — | — | — | — | | |
| and | | | | | | | | | | | | |
| Func- | | | | | | | | | | | | |
| tional | | | | | | | | | | | | |
| Aids | | | | | | | | | | | | |
| Fluor- | 0.03 | 0.03 | — | — | 0.02 | | — | — | 0.03 | 0.03 | 0.03 | 0.03 |
| escent | | | | | | | | | | | | |
| Agent | | | | | | | | | | | | |
| Water | 10.47 | 10.47 | 24.48 | 24.48 | 6.98 | 44.12 | 46.67 | 46.67 | 10.47 | 10.47 | 4.76 | 15.47 |

*Triethanol-based, 75% active with 25% propylene glycol;
^{&}Methyldiethanolamineethanol-based, 70% active with 30% PEG400; Triethanol amine-based,
^{#}80% active with 20% C18-fatty acid.
^{$}TMPD = 2,2,4-Trimethyl-1,3-pentanediol

### Inventive Example 1. Batch Making of 275 Gal 60% Active Non-Shear Sensitive Softening Emulsion with 1,2-Hexanediol

This example is intended to demonstrate concentrated, shear stable, and translucent softening compositions can be prepared with quaternary softener actives having desired properties such as a degree of unsaturation >60 and softening compositions with desired principal solvents (e.g. 1,2-hexanediol) and solvent/water ratio

SAMPLE 1—Batch making of non-shear sensitive 60% active Di(Alkylcarboxyethyl)-hydroxyethyl-methylammonium methyl sulfate softening composition (275 gal) was conducted according to SAMPLE 1 provided in TABLE 1, shown below. Added 828.309 kg of 75.68% active Di(Alkylcarboxyethyl)-hydroxyethyl-methylammonium methyl sulfateDi(Alkylcarboxyethyl)-hydroxyethyl-methylammonium methyl sulfate SOFTENER ACTIVE into main process tank, began stirring at 25 Hz at room temperature (approximately 25° C.). Then added 100.154 kg 1,2-hexanediol and stirred for 15 minutes at 10 Hz. In another pre-mix vessel, dissolved 0.313 kg 100% active Tinopal CBS-X in 115.996 kg distilled water at room temperature (approximately 25° C.). Finally added, room temperature water+Tinopal solution and stirred for another 15 minutes at ˜25° C. Once complete, transferred the finished batch to appropriate sealed container for storage. % activity was measured using the QUAT titration method disclosed herein.

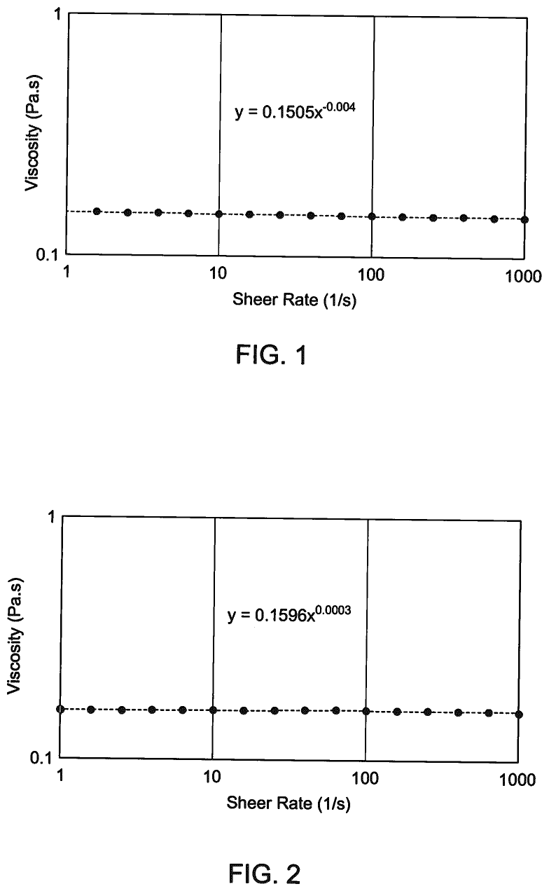

Finished emulsion was clear and translucent exhibiting non-shear sensitive rheology profile with viscosity of 147.8 cP (FIG. 1, TABLE 2, and TABLE 3)

### Inventive Example 2. Batch Making of 276 Gal 60% Active Non-Shear Sensitive Softening Emulsion with TMPD

This example is intended to demonstrate concentrated, shear stable, and translucent softening compositions can be prepared with quaternary softener actives having desired properties such as degree of unsaturation >60 and softening compositions with desired principal solvents (e.g. TMPD) and solvent/water ratio

Batch making of 60% active Di(Alkylcarboxyethyl)-hydroxyethyl-methylammonium methyl sulfateDi(Alkylcarboxyethyl)-hydroxyethyl-methylammonium methyl sulfate emulsion with TMPD (276 gal) was conducted according SAMPLE 2 provided in TABLE 1

SAMPLE 2—In the main mixing kettle, added 828.309 kg 5.68% active Di(Alkylcarboxyethyl)-hydroxyethyl-methylammonium methyl sulfate SOFTENER ACTIVE, began stirring at 30 Hz, and heated to 55° C. before proceeding. In another pre-mix vessel, added room temperature 115.996 kg deionized water. Added 313 g Tinopal CBS-X and mix aqueous solution until Tinopal was dissolved. Added 100.154 kg pre-melted (65° C.) 2,2,4-Trimethyl-1,3-pentanediol (TMPD) into the main process tank. Mixed main process tank for 30 minutes at 20 Hz before proceeding. Added the room temperature (approximately 25° C.) aqueous phase to main process tank. Mixed for 30 minutes. Cooled batch to room temperature. % activity was measured using the QUAT titration method disclosed herein.

Finished emulsion was clear and translucent exhibited non-shear sensitive rheology profile with viscosity of 160.5 cP (FIG. 2, TABLE 2, and TABLE 3)

TABLE 2
Viscosity Data of Inventive tissue softener compositions.

| Softener Compositions | Viscosity (cps at 100/s) | |
|---|---|---|
| Inventive SAMPLE 1 | 147.8 | cP |
| Inventive SAMPLE 2 | 160.5 | cP |
| Inventive SAMPLE 3 | 49.7 | cP |

TABLE 3
Turbidity and phase clarity of tissue softener compositions.

| | Inv | Inv | Inv | Inv | Inv | Com | Com | Com | Com |
|---|---|---|---|---|---|---|---|---|---|
| | SAMPLE | SAMPLE | SAMPLE | SAMPLE | SAMPLE | SAMPLE | SAMPLE | SAMPLE | SAMPLE |
| | 1 | 2 | 3 | 4 | 5 | 5 | 6 | 7 | 8 |
| Turbidity | <50 | <50 | <50 | <50 | <50 | >50 | >50 | >50 | >50 |
| (NTU) | | | | | | | | | |
| Is the material | YES | YES | YES | YES | YES | NO | NO | NO | NO |
| clear and | | | | | | | | | |
| translucent at | | | | | | | | | |
| Room | | | | | | | | | |
| temperature | | | | | | | | | |
| (approximately | | | | | | | | | |
| 25° C.) | | | | | | | | | |

### Inventive Example 3.—Batch Making (200 g) 40% Active Softener Emulsion Solvent/Water Ratio 0.9 According to the Composition Provided in Table 1

This example is intended to demonstrate shear and phase stability of 60% active softening composition disclosed in Example 1 can be maintained when diluted, provided the inventive solvent/water ratio is not violated.

SAMPLE 3—Batch making of 40% active Di(Alkylcarboxyethyl)-hydroxyethyl-methylammonium methyl sulfate emulsion from 59.6% active Di(Alkylcarboxyethyl)-hydroxyethyl-methylammonium methyl sulfate solvent (1,2-hexanediol)/Water Ratio=0.91 was conducted according to SAMPLE 3 provided in TABLE 1. To make 200 g of 40% active Di(Alkylcarboxyethyl)-hydroxyethyl-methylammonium methyl sulfate material with TMPD and water dilution, 134.2 g 59.6% active clear Di(Alkylcarboxyethyl)-hydroxyethyl-methylammonium methyl sulfate SOFTENER ACTIVE was added into vessel followed by addition of 31.2 g 1,2-hexanediol under stirring at room temperature. Finally, 34.6 g water was added to maintain solvent/water ratio at a starting level of 0.91. The resulting material maintained clarity and shear stability of starting 59.6% material. The % activity was measured using the QUAT titration method disclosed herein.

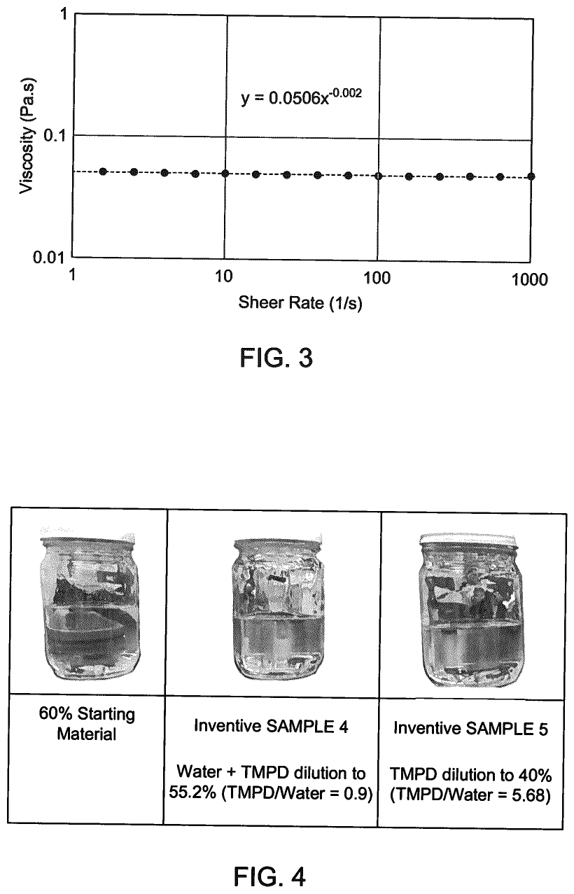

Finished emulsion was clear and translucent exhibiting non-shear sensitive rheology profile with viscosity of 49.7 cP (FIG. 3, TABLE 2, and TABLE 3)

### Inventive Example 4.—Batch Making (200 g) 55.2% Active Softener Emulsion with Solvent (TMPD)/Water Ratio of 0.91

This example is intended to demonstrate shear and phase stability of 60% active softening composition (SAMPLE 2) disclosed in Example 2 can be maintained when diluted provided the inventive solvent/water ratio is not violated.

SAMPLE 4—Batch making of 55.2% active Di(Alkylcarboxyethyl)-hydroxyethyl-methylammonium methyl sulfate emulsion from 60% active Di(Alkylcarboxyethyl)-hydroxyethyl-methylammonium methyl sulfate solvent (TMPD)/water Ratio=0.91 was conducted according to SAMPLE 4 provided in TABLE 1. The % activity was measured using the QUAT titration method disclosed herein. To make 18.17 kg of 55.2% active Di(Alkylcarboxyethyl)-hydroxyethyl-methylammonium methyl sulfate material with TMPD and water dilution, 17.413 kg 60% active clear Di(Alkylcarboxyethyl)-hydroxyethyl-methylammonium methyl sulfate SOFTENER ACTIVE was added into vessel followed by addition of 757.1 g molten TMPD (65° C.) under stirring at room temperature (approximately 25° C.). Finally, 757.1 g water was added to maintain TMPD/water ratio at a starting level of 0.91. The resulting material maintained clarity and shear stability of starting 60% material.

Finished emulsion was clear and translucent (FIG. 4) and TABLE 3.

### Inventive Example 5.—Batch Making 40% Active Softener Emulsion with TMPD Solvent/Water Ratio 5.68

This example is intended to demonstrate shear and phase stability of 60% active softening composition (SAMPLE 2) disclosed in Example 2 can be maintained when diluted provided the inventive solvent/water ratio is not violated.

SAMPLE 5—Batch making of 40% active Di(Alkylcarboxyethyl)-hydroxyethyl-methylammonium methyl sulfate emulsion from 60% active Di(Alkylcarboxyethyl)-hydroxyethyl-methylammonium methyl sulfateDi(Alkylcarboxyethyl)-hydroxyethyl-methylammonium methyl sulfate emulsion with TMPD dilution (5 gal)-solvent (TMPD)/water Ratio=5.68 was conducted according to SAMPLE 5 provided in TABLE 1. To make 18.17 kg 40% active Di(Alkylcarboxyethyl)-hydroxyethyl-methylammonium methyl sulfate material with TMPD dilution, added 12.62 kg 60% active clear Di(Alkylcarboxyethyl)-hydroxyethyl-methylammonium methyl sulfate SOFTENER ACTIVE into vessel followed by addition of 6.309 kg molten TMPD (65° C.) under stirring at room temperature. The resulting material maintained clarity and shear stability of starting 60% material. The % activity was measured using the QUAT titration method disclosed herein.

Finished emulsion was clear and translucent (FIG. 4 and TABLE 3).

### Inventive Example 6

This example is intended to demonstrate that 60% active softening composition (SAMPLE 1) described in Example 1 maintains its shear stable profile across a wide temperature range.

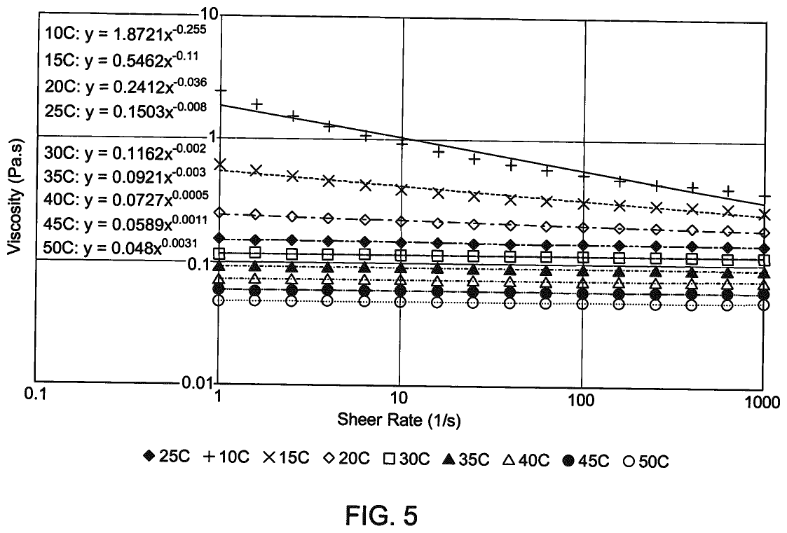

Rheology profile of 60% active softening composition (SAMPLE 1) described in EXAMPLE 1 was investigated as a function of temperature. Viscosities at 100 l/s shear rate are tabulated in TABLE 4 (below) and flow rheology curves are shown in FIG. 5. Viscosity increased at lower temperatures but the room temperature non-shear sensitive profile was maintained at lower temperatures >15-20° C.

TABLE 4
Viscosity Data of tissue softener compositions
at Different Temperatures.

| | Inv Ex 6 | Inv Ex 7 |
|---|---|---|
| Temperature | Viscosity | Viscosity |
| (° C.) | (100 1/s) | (100 1/s) |
| 10 | 613.1 cP | 533.3 cP |
| 15 | 329.2 cP | 319.2 cP |
| 20 | 220.0 cP | 202.6 cP |
| 25 | 160.7 cP | 145.1 cP |
| 30 | 127.8 cP | 115.2 cP |
| 35 | 100.1 cP | 90.9 cP |
| 40 | 79.7 cP | 72.7 cP |
| 45 | 64.3 cP | 59.0 cP |
| 50 | 52.5 cP | 48.4 cP |

### Inventive Example 7

This example is intended to demonstrate that 60% active softening composition (SAMPLE 2) described in EXAMPLE 2 maintains its shear stable/phase profile across a wide temperature range.

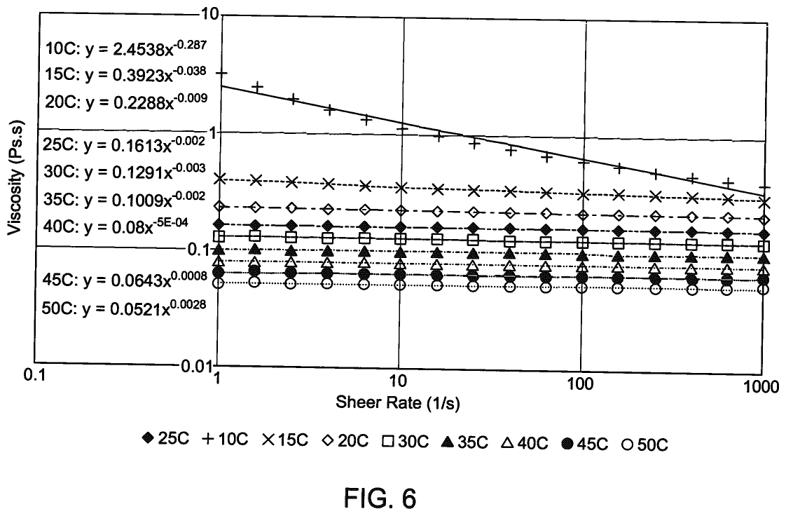

Rheology profile of 60% active softening composition described in (SAMPLE 2) described in EXAMPLE 2 was investigated as a function of temperature. Viscosities at 100 l/s shear rate are tabulated in TABLE 4 and flow rheology curves are shown in FIG. 6. Viscosity increased at lower temperatures, but the room temperature non-shear sensitive profile was maintained at lower temperatures >15-20° C.

### Inventive Example 8. Temperature Stability 40° C.

This example is intended to demonstrate that 60% active softening composition (SAMPLE 1) described in EXAMPLE 1 recovers its room temperature (approximately 25° C.) shear/phase stable profile when stored at 4.4° C. up to 3 months.

The following procedure was followed:
1. Obtained three 8 oz wide mouth glass jar with black phenolic cap lined with PTFE/LDPE.
2. Cleaned the glass jars and lids using isopropyl alcohol and a paper towel.
3. Filled glass jars with approximately 5 oz Di(Alkylcarboxyethyl)-hydroxyethyl-methylammonium methyl sulfate emulsion.
4. Securely tightened cap on both jars and placed the samples in controlled temperature box maintained at 4.4° C.
5. After one month, one of the samples was removed and visually inspected for phase clarity. After reaching room temperature (approximately 25° C.), repeated the visual inspection and conducted flow rheology analysis up to 1000 l/s at 25° C. Viscosities at 100 l/s and 1000 l/s were reported in TABLE 5.
6. After two months, removed the second sample and visually inspected for phase clarity. After reaching room temperature (approximately 25° C.), repeated the visual inspection and conducted flow rheology analysis up to 1000 l/s at 25° C. Viscosities at 100 l/s and 1000 l/s were reported in TABLE 5. After three months, removed the second sample and visually inspected for phase clarity. After reaching room temperature (approximately 25° C.), repeated the visual inspection and conducted flow rheology analysis up to 1000 l/s at 25° C. Viscosities at 100 l/s and 1000 l/s were reported in TABLE 5.

Viscosities recorded in TABLE 5 (shown below) demonstrate the 60% softening active composition maintains its non-shear sensitivity room temperature (approximately 25° C.) after 3 months of storage at 4° C.

TABLE 5
Rheology and turbidity data demonstrating temperature stability of tissue softener compositions.

| | | Inv | | Inv |
|---|---|---|---|---|
| | Inv Sample 6 | Sample 7 | Inv Sample | Sample 9 |
| | (4.4° C.) | (0° C.) | 8 (Cyclic) | (65.5° C.) |
| Initial Turbidity (NTU) at room temperature | <50 | <50 | <50 | <50 |
| (approximately 25° C.) | | | | |
| Is the material clear and translucent at room | YES | YES | YES | YES |
| temperature (approximately 25° C.) initially? | | | | |
| Initial Ambient Viscosity (cP) at 100 1/s | 147.8 | 147.8 | 147.8 | 147.8 |
| Initial Ambient Viscosity (cP) at 1000 1/s | 145.1 | 145.1 | 145.1 | 145.1 |
| Turbidity (NTU) at room temperature | <50 | — | — | — |
| (approximately 25° C.) after storage at 4.4° C. for 3 | | | | |
| months | | | | |
| Is the material clear and translucent at room | YES | — | — | — |
| temperature (approximately 25° C.) after storage at | | | | |
| 4.4° C. for 3 months? | | | | |
| Ambient Viscosity (cP) at 100 1/s after storage at | 146.2 | — | — | — |
| 4.4° C. for 3 months | | | | |
| Ambient Viscosity (cP) at 1000 1/s after storage at | 143.9 | — | — | — |
| 4.4° C. for 3 months | | | | |
| Turbidity (NTU) at room temperature | — | <50 | — | — |
| (approximately 25° C.) after storage at 0° C. for 1 | | | | |
| week | | | | |
| Is the material clear and translucent at room | — | YES | — | — |
| temperature (approximately 25° C.) after storage at | | | | |
| 0° C. for 1 week? | | | | |
| Ambient Viscosity (cP) at 100 1/s after storage at | — | 148.9 | — | — |
| 0° C. for 1 week | | | | |
| Ambient Viscosity (cP) at 1000 1/ after storage at | — | 146.3 | — | — |
| 0° C. for 1 week | | | | |
| Turbidity (NTU) at room temperature | — | — | — | <50 |
| (approximately 25° C.) after storage at 65.5° C. | | | | |
| for 1 week | | | | |
| Is the material clear and translucent at room | — | — | — | YES |
| temperature (approximately 25° C.) after storage at | | | | |
| 65.5° C. for 1 week? | | | | |
| Ambient Viscosity (cP) at 100 1/s after storage at | — | — | — | 157.0 |
| 65.5° C. for 1 week | | | | |
| Ambient Viscosity (cP) at 1000 1/ after storage at | — | — | — | 154.1 |
| 65.5° C. for 1 week | | | | |
| Turbidity (NTU) at room temperature | — | — | <50 | — |
| (approximately 25° C.) after cycling between | | | | |
| ambient and 4.4° C. for 7 days | | | | |
| Is the material clear and translucent at room | — | — | YES | — |
| temperature (approximately 25° C.) after cycling | | | | |
| between ambient and 4.4° C. for 7 days | | | | |
| Ambient Viscosity (cP) at 100 1/s after cycling | — | — | 149.0 | — |
| between ambient and 4.4° C. for 7 days | | | | |
| Ambient Viscosity (cP) at 1000 1/ cycling between | — | — | 146.2 | — |
| ambient and 4.4° C. for 7 days | | | | |

### Inventive Example 9. Temperature Stability 0° C.

This example is intended to demonstrate that 60% active softening composition (SAMPLE 1) described in EXAMPLE 1 recovers its room temperature (approximately 25° C.) shear/phase stable profile when stored at 0° C.

Inventive EXAMPLE 9 describes low temperature 0° C. stability of Di(Alkylcarboxyethyl)-hydroxyethyl-methylammonium methyl sulfate emulsion which maintains its initial viscosity, shear stability, phase clarity/color when it is frozen at 0° C. for 7 days.
1. Obtained two 8 oz wide mouth glass jar with black phenolic cap lined with PTFE/LDPE.
2. Cleaned the glass jars and lids using isopropyl alcohol and a paper towel.
3. Filled glass jars with approximately 5 oz Di(Alkylcarboxyethyl)-hydroxyethyl-methylammonium methyl sulfate emulsion.
4. Securely tightened cap on both jars and placed the samples in laboratory freezer prechilled to 0° C.
5. After 3 days, one of the samples was removed and visually inspected for phase clarity. After reaching room temperature (approximately 25° C.), repeated the visual inspection and conducted flow rheology analysis up to 1000 l/s at 25° C. Viscosities at 100 l/s and 1000 l/s are reported in Table 5.
6. After 7 days, removed the second sample and visually inspected for phase clarity. After reaching room temperature (approximately 25° C.), repeated the visual inspection and conducted flow rheology analysis up to 1000 l/s at 25° C. Viscosities at 100 l/s and 1000 l/s were reported in TABLE 5.

Ambient viscosities recorded in TABLE 5 demonstrate the 60% softening active composition maintains its non-shear sensitivity at room temperature (approximately 25° C.) after one week of storage at 0° C.

### Inventive Example 10. Temperature Stability Cycling Between 25° C. and 4.4° C.

This example is intended to demonstrate that 60% active softening composition (SAMPLE 1) described in EXAMPLE 1 can be reversibly cycled between 4.4° C. and 25° C. without losing its room temperature (approximately 25° C.) shear/phase stable profile,
1. Obtained one 8 oz wide mouth glass jar with black phenolic cap lined with PTFE/LDPE.
2. Cleaned the glass jar and lid using isopropyl alcohol and a paper towel.
3. Filled glass jar with approximately 5 oz Di(Alkylcarboxyethyl)-hydroxyethyl-methylammonium methyl sulfate emulsion.
4. Securely tightened cap on jar and placed the samples in controlled temperature box maintained at 4.4° C.
5. After 16 hours of storage in the 4.4° C. controlled temperature box, the sample was moved to ambient storage on a laboratory benchtop. Immediately upon removal from the controlled temperature box the sample was visually inspected for phase clarity.
6. After 8 hours of ambient storage on the laboratory bench, visual inspection for phase clarity was repeated and sample was moved back to the 4.4° C. controlled temperature box.
7. Steps 5 and 6 were repeated for a total of 7 days. At the end of the final room temperature (approximately 25° C.) storage period the sample was visually inspected for phase clarity and flow rheology analysis was conducted up to 1000 l/s at 25° C. Viscosities at 100 l/s and 1000 l/s are reported in TABLE 5.

Ambient viscosities recorded in TABLE 5 demonstrate the 60% softening active composition maintains its non-shear sensitivity at room temperature (approximately 25° C.) after one week of storage cycling between 25° C. and 4.4° C.

### Inventive Example 11. Temperature Stability 65.5° C.

This example is intended to demonstrate that 60% active softening composition (SAMPLE 1) described in Inventive EXAMPLE 1 displays elevated temperature stability recovering back to room temperature (approximately 25° C.) shear/phase stable profile,
1. Obtained two 8 oz wide mouth glass jar with black phenolic cap lined with PTFE/LDPE.
2. Cleaned the glass jars and lids using isopropyl alcohol and a paper towel.
3. Filled glass jars with approximately 5 oz Di(Alkylcarboxyethyl)-hydroxyethyl-methylammonium methyl sulfate emulsion.
4. Lightly tightened cap on both jars and placed the samples in oven preheated to 65.5° C.
5. After 3 days, one of the samples was removed and visually inspected for phase clarity. After reaching room temperature (approximately 25° C.), repeated the visual inspection and conducted flow rheology analysis up to 1000 l/s at 25° C. Viscosities at 100 l/s and 1000 l/s are reported in TABLE 5.
6. After 7 days, removed the second sample and visually inspected for phase clarity. After reaching room temperature (approximately 25° C.), repeated the visual inspection and conducted flow rheology analysis up to 1000 l/s at 25° C. Viscosities at 100 l/s and 1000 l/s were reported in TABLE 5.

Ambient viscosities recorded in TABLE 5 demonstrate the 60% softening active composition maintains its non-shear sensitivity at room temperature (approximately 25° C.) after one week of storage at 65.5° C.

### Inventive Example 12

This example is intended to demonstrate room temperature shelf-life of 60% active softener composition (SAMPLE 2) described in EXAMPLE 2

60% active softener composition (SAMPLE 2) described in EXAMPLE 2 was stored at 25° C. and 60% RH in a temperature and humidity control room for 3 years and monitored for shear and phase stability. As shown in TABLE 6 (below), the softening composition (SAMPLE 2) exhibited excellent shelf-life remaining clear and translucent without any changes in viscosity.

TABLE 6
Viscosity and turbidity of softener composition
(SAMPLE 2) stored at 25° C. for 3 years.

| | | 3 | 6 | | |
|---|---|---|---|---|---|
| | Initial | months | months | 1 yr | 2 yrs |
| Viscosity | 161.6 | 163.5 | 163.2 | 162.2 | 158.6 |
| (cps at 100 1/s) | | | | | |
| Turbidity | <50 | <50 | <50 | <50 | <50 |
| (NTU) | | | | | |

### Inventive Example 13. Water Activity of 60% Softener Emulsion

This example is intended to demonstrate non-microsusceptible profile of 60% active softener composition (SAMPLE 2) described in Inventive EXAMPLE 2

Water activity of 60% active Di(Alkylcarboxyethyl)-hydroxyethyl-methylammonium methyl sulfateDi(Alkylcarboxyethyl)-hydroxyethyl-methylammonium methyl sulfate emulsion.

Following the WATER ACTIVITY METHOD described herein, the Rotronic measurement cup was filled with the Di(Alkylcarboxyethyl)-hydroxyethyl-methylammonium methyl sulfate emulsion and the lid was closed. Once the sample temperature was equilibrated to the temperature of the probe, the lid was removed from the cup and the cup was placed into the probe for measurements. Water activity was measured as 0.40% (TABLE 7, shown below).

TABLE 7
Water activity and microsusceptibility comparison
of tissue softener compositions

| | Water Activity, Aw | Considered Micro |
|---|---|---|
| | (%) | Susceptible |
| Inventive SAMPLE 2 | 0.40 | NO |
| Comparative Example 9 | 0.85 | YES |
| Comparative Example 10 | 0.9 | YES |

### Inventive Example 14

This example is intended to demonstrate sanitary tissue product making that contains 60% active quaternary ammonium tissue softener compositions (SAMPLES 1 and 2).

Tissue products containing surface applied softener compositions (SAMPLE 1 and SAMPLE 2) were produced via slot coating application. The softener emulsion is applied onto a moving web with a slot coater that was operated in tensioned web mode. The fluid was supplied to the slot coater with a progressive cavity pump. Variable speed pump motor was used to control fluid flow. The slot coater was an infinite cavity design, and the shimmed slot was sized to keep slot coat pressure in a range from 5 to 80 psi. In this example, web speed was 400-800 ft/min with add-on of 5-30 #/tne (118-710 mg/sqm) and fluid flow of 9 g/min-98 g/min. Slot shim was 0.003 inches.

### Comparative Example 1

This example is intended to demonstrate shear sensitive rheology profile of 37.5% active Ditallow Ethyl Ester Dimethyl Ammonium Methyl Sulfate (DEEDMAMS) (IV<60) softening composition (Comparative SAMPLE 1) at 25° C.

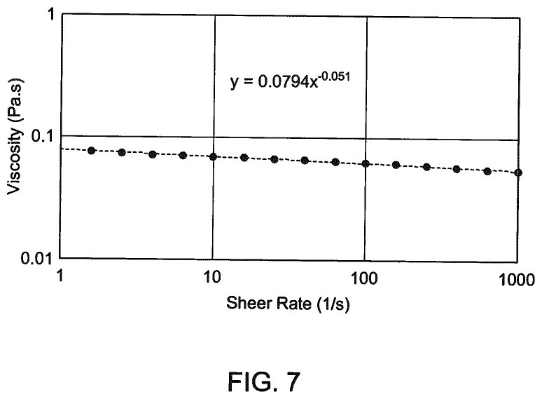

A 37.5% active Ditallow Ethyl Ester Dimethyl Ammonium Methyl Sulfate softening emulsion was prepared using the procedure disclosed in U.S. Ser. No. 11/732,417B2 and its rheology profile was analyzed to demonstrate shear sensitive profile (see FIG. 1). The % activity was measured using the QUAT titration method disclosed in U.S. Ser. No. 11/732,417B2. The material showed shear thinning profile as a function of shear rate as shown in FIG. 7. Additionally, when it is exposed to high shear rates for an extended period of time, the Comparative SAMPLE's viscosity increased and was not-suitable for surface application.

### Comparative Example 2

This example demonstrated the shear sensitive rheology profile of 37.5% active Ditallowoyl Ethyl Ester Dimethyl Ammonium Methyl Sulfate (IV<60) softening composition (Comparative SAMPLE 2) at different temperatures.

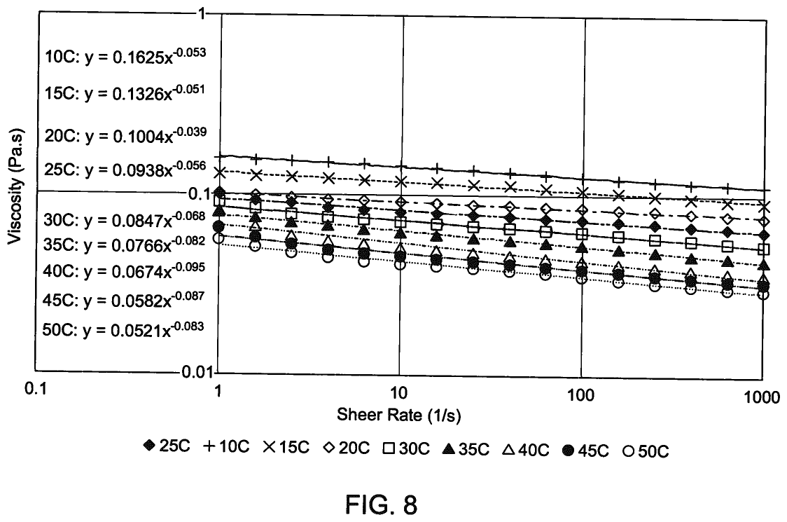

A 37.5% active Ditallowoyl Ethyl Ester Dimethyl Ammonium Methyl Sulfate softening emulsion was prepared using the procedure disclosed in U.S. Ser. No. 11/732,417B2 and its temperature stability, resulting rheological changes, and phase changes were analyzed. When exposed to sub-normal temperatures, the material became more shear sensitive and it underwent irreversible phase transformation with emulsion destabilizing and thickening (FIG. 8), which made the material not-suitable for surface application.

### Comparative Example 3

This example demonstrated that clear/translucent and shear stable softening emulsions cannot be made with quaternary actives with chemical composition of DMEA-based quaternary amine (Ditallowoyl Ethyl Ester Dimethyl Ammonium Methyl Sulfate) with an IV value of 56 (Comparative SAMPLE 3). Batch making of 60% active softening emulsion was conducted according to the composition provided in TABLE 1.

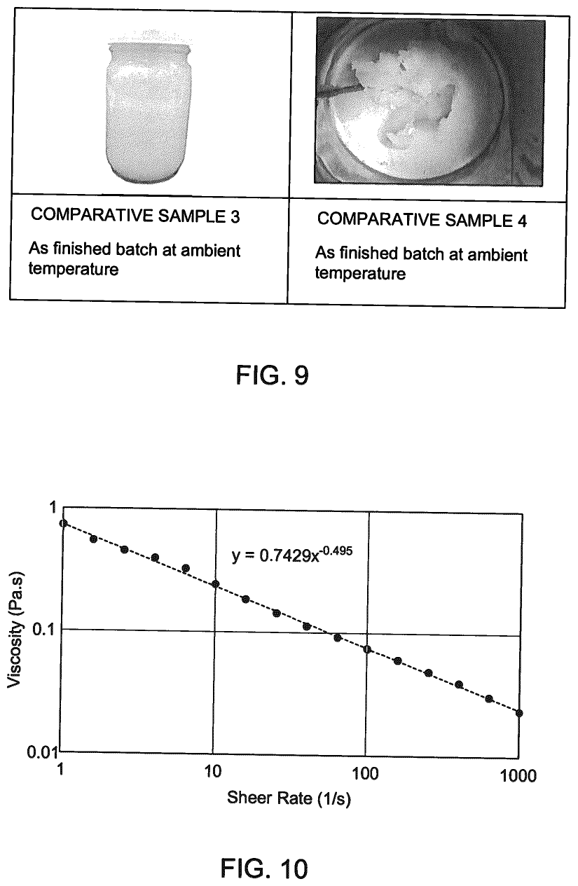

Added 16.22 kg 70% active Ditallow Ethyl Ester Dimethyl Ammonium Methyl Sulfate (DEEDMAMS) into main process tank and heated it to 90° C. to melt it and began stirring at 20 Hz. Premelt 1.814 kg TMPD pellets in a separate vessel at 65° C. In another pre-mix vessel, dissolved 5,678 g 100% active Tinopal CBS-X in 883.79 g distilled water at room temperature (approximately 25° C.). Once DXP5558-66 in the main process tank is fully melted at 90° C. by visual inspection, added required amount of pre-melted (65° C.) 2,2,4-Trimethyl-1,3-pentanediol (TMPD) into the main process tank and stirred for 15 minutes while maintaining temperature at 90° C. Finally added room temperature (approximately 25° C.) water+Tinopal premix and stirred for additional 15 minutes at 90° C. Once the finished batch is cooled to room temperature (approximately 25° C.) it eventually formed a lotion like viscous material as shown in FIG. 9

### Comparative Example 4

This example demonstrated that clear/translucent and shear stable softening emulsions cannot be made with quaternary actives with chemical composition of Triethanol amine (TEA)-based QUAT with IV value of 42 (Comparative SAMPLE 4). Batch making of 60% active softening emulsion was conducted according to the composition provided in TABLE 1.

To make a batch, added 1000 g 80% active quaternary ammonium compound into main process tank, heated it to 65° C. to melt it and began stirring at 250 rpm. Premelted 95.86 g TMPD pellets in a separate vessel at 65° C. In another pre-mix vessel, dissolved 0.3 g 100% active Tinopal CBS-X in 153.84 g distilled water at room temperature (approximately 25 oC) to make aqueous phase. Once the QUAT active in the main process tank was fully melted by visual inspection at 65° C., added pre-melted (65° C.) 2,2,4-Trimethyl-1,3-pentanediol (TMPD) into the main process tank and stirred for 15 minutes while maintaining temperature at 65° C. Finally added the aqueous phase and stirred for additional 15 minutes at 65° C. Once the finished batch was cooled to room temperature (approximately 25° C.) it eventually formed lotion like viscous material as shown in FIG. 9

### Comparative Example 5

This example demonstrated that clear/translucent and shear stable softening emulsions cannot be made when solvent/water ratio is <0.16 (Comparative SAMPLE 5). Batch making of 40% active softening emulsion with 1,2-hexanediol as the solvent was conducted according to the composition provided in TABLE 1.

To make 200 g batch, added 134.2 g 59.6% active Di(Alkylcarboxyethyl)-hydroxyethyl-methylammonium methyl sulfate emulsion into a vessel followed by addition of 65.8 g deionized water under stirring at room temperature (approximately 25° C.). The resulting material was gel-like with high viscosity with shear sensitive/thinning behavior (FIG. 10 and TABLE 3).

### Comparative Example 6

This example demonstrated that clear/translucent and shear stable softening emulsions cannot be made when solvent/water ratio is 0.16 (Comparative SAMPLE 6). Batch making of 40% active softening emulsion with TMPD as the solvent was conducted according to the composition provided in TABLE 1.

Batch making of 40% active Di(Alkylcarboxyethyl)-hydroxyethyl-methylammonium methyl sulfate emulsion from 60% active Di(Alkylcarboxyethyl)-hydroxyethyl-methylammonium methyl sulfate emulsion with water dilution (5 gal)-TMPD/Water Ratio=0.16.

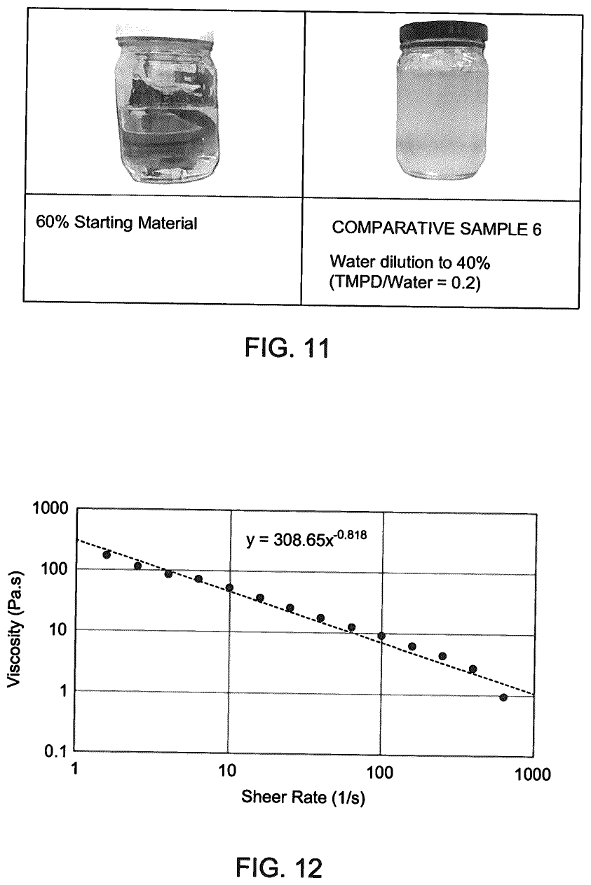

Added 12.618 kg 60% active Di(Alkylcarboxyethyl)-hydroxyethyl-methylammonium methyl sulfate emulsion into vessel followed by addition of 6.309 kg deionized water under stirring at room temperature (approximately 25° C.). The resulting material was gel-like with high viscosity (FIG. 11 and TABLE 3)

### Comparative Example 7

This example demonstrated that clear/translucent and shear stable softening emulsions cannot be made when glycerin is used as the principal solvent (Comparative SAMPLE 7). Batch making of 60% active Di(Alkylcarboxyethyl)-hydroxyethyl-methylammonium methyl sulfate softening emulsion with glycerin as the solvent was conducted according to the composition provided in TABLE 1.

To make 1000 g batch, added 794.6 g of 59.6% active Di(Alkylcarboxyethyl)-hydroxyethyl-methylammonium methyl sulfate softener active into a stainless steel vessel and heated to 50° C. in water bath. Under stirring (˜125 rpm) added 95 g glycerin and stirred for 15 minutes. In a separate vessel, prepared the aqueous solution by dissolving 0.3 g fluorescent agent in 110.1 g deionized water at 25° C. Slowly added aqueous phase to stainless steel vessel containing softener active and glycerin blended at 50° C. under stirring (250 rpm) and mixed for 15 minutes at 50° C. The finished batch was cooled to room temperature (approximately 25° C.). It formed a thick, non-translucent gel with shear thinning rheology behavior as shown in FIG. 12 and TABLE 3.

### Comparative Example 8

This example demonstrated that clear/translucent and shear stable softening emulsions cannot be made when 1,3-butanediol is used as the principal solvent (Comparative SAMPLE 8). Batch making of 60% active Di(Alkylcarboxyethyl)-hydroxyethyl-methylammonium methyl sulfate softening emulsion with 1,3-butanediol as the solvent was conducted according to the composition provided in TABLE 1.

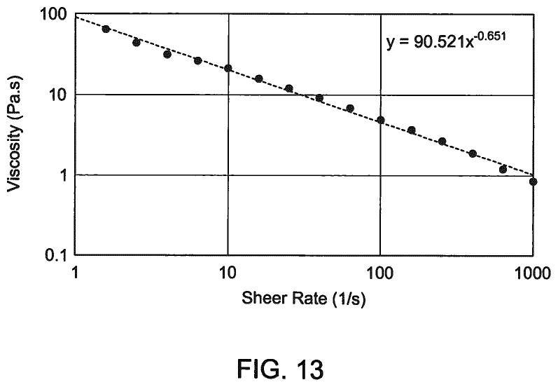

To make 500 g batch, added 397.3 g of 59.6% active Di(Alkylcarboxyethyl)-hydroxyethyl-methylammonium methyl sulfate softener active into a stainless steel vessel and heated to 50° C. in a water bath. Under stirring (˜125 rpm) added 47.5 g 1,3-butanediol and stirred for 15 minutes. In a separate vessel, prepared the aqueous solution by dissolving 0.15 g fluorescent agent in 55.1 g deionizedwater at 25° C. Slowly added aqueous phase to stainless steel vessel containing softener active and 1,3-butanediol blended at 50° C. under stirring (150 rpm)) and mixed for 15 minutes at 50° C. The finished batch was cooled to room temperature (approximately 25° C.). It formed a thick, non-translucent gel with shear thinning rheology behavior as shown in FIG. 13 and TABLE 3.

### Comparative Example 9

This example is intended to demonstrate that concentrated softener composition based on 37.5% active Ditallow Ethyl Ester Dimethyl Ammonium Methyl Sulfate disclosed in U.S. Ser. No. 11/732,417B2 is microsuscpetible (Comparative SAMPLE 9). The 37.5% active emulsion was prepared using the procedure disclosed in U.S. Ser. No. 11/732,417B2 and its water activity was measured. Following the water activity method described herein, the Rotronic measurement cup was filled with the 40% active Ditallow Ethyl Ester Dimethyl Ammonium Methyl Sulfate (DEEDMAMS) emulsion and the lid was closed. Once the sample temperature was equilibrated to the temperature of the probe at 25° C., the lid was removed from the cup and the cup was placed into the probe for measurements. Water activity was measured as 0.85% (TABLE 6)

### Comparative Example 10

This example demonstrated that diluted 20% active version of softener composition (Comparative SAMPLE 10) based on 37.5% active Ditallow Ethyl Ester Dimethyl Ammonium Methyl Sulfate disclosed in U.S. Ser. No. 11/732,417B2 is microsuscpetible. 533.3 g of 37.5% active Ditallow Ethyl Ester Dimethyl Ammonium Methyl Sulfate (DEEDMAMS) softening emulsion was prepared using the procedure disclosed in U.S. Ser. No. 11/732,417B2 and diluted to 20% activity with the addition of 466.7 g distilled water. Then the water activity of 20% active emulsion was measured following the water activity method described herein, the Rotronic measurement cup was filled with the 20% active Ditallow Ethyl Ester Dimethyl Ammonium Methyl Sulfate (DEEDMAMS) emulsion and the lid was closed. Once the sample temperature was equilibrated to the temperature of the probe at 25° C., the lid was removed from the cup and the cup was placed into the probe for measurements. Water activity was measured as 0.9% (TABLE 6)

The dimensions and values disclosed herein are not to be understood as being strictly limited to the exact numerical values recited. Instead, unless otherwise specified, each such dimension is intended to mean both the recited value and a functionally equivalent range surrounding that value.

For example, a dimension disclosed as “40 mm” is intended to mean “about 40 mm.” Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A surface softening composition comprising:
water;
solvent;
at least 25% by weight of a softener active; and
wherein the composition is non-shear sensitive.

2. The surface softening composition according to claim 1 wherein the softener active has a fatty acid Iodine Value (IV) of 60 or greater.

3. The surface softening composition according to claim 1 wherein the softener active has a fatty acid IV of about 100 or more.

4. The surface softening composition according to claim 1 wherein softener active has a fatty acid IV of at least 60 to about 140.

5. The surface softening composition according to claim 1 having a solvent/water ratio greater than 0.6.

6. The surface softening composition according to claim 1 having a solvent/water ratio of from about 0.6 to about 12.

7. The surface softening composition according to claim 1 having a Temperature Stability between 0° C. and about 65° C. recovering to initial 25° C. non-shear sensitive stable viscosity within 10%.

8. The surface softening composition according to claim 1 having a water activity of less than 0.6.

9. The surface softening composition according to claim 1 having a solvent/water ratio greater than 0.6.

10. The surface softening composition according to claim 1 having a non-shear sensitive viscosity of less than 400 cP as measured according to the Viscosity Test Method.

11. The surface softening composition according to claim 1 comprising from about 25% to about 70% softener active having non-shear behavior when exposed to shear rates from 0.1 sec-1 to up to 1,000,000 sec-1 above 20° C.

12. The surface softening composition according to claim 1 having a non-shear sensitive viscosity at 25° C. of from about 25 cP to about 300 cP as measured according to the Viscosity Test Method.

13. The surface softening composition according to claim 1 having a long term phase stability of from about 6 months to about 3 years at about 25° C.

14. The surface softening composition according to claim 1 comprising from about 2% to about 80% softener active, by weight of the surface softening composition.

15. The surface softening composition according to claim 1 comprising at least 5% solvent, by weight of the surface softening composition.

16. The surface softening composition according to claim 1 wherein the solvent has ClogP of from about 2.0 to less than 15.

17. The surface softening composition according to claim 1 wherein the solvent has ClogP of from about 0.64 to about 2.6.

18. The surface softening composition according to claim 1 wherein the solvent comprises a polyol.

19. The surface softening composition according to claim 18 wherein the solvent comprises at least one of isomers of mono-ols; hexane-diols; heptane-diols, octane-diols; nonone-diols, glyceryl ethers, di(hydroxyalakyl)ethers, saturated and unsaturated alicyclic diols and their derivatives, alkoxylated derivatives of C3-8 diols, or aromatic diols.

20. The surface softening composition according to claim 19 wherein the diol comprises 1,2-hexanediol.

21. The surface softening composition according to claim 19 wherein the diol comprises 2,2,4-Trimethyl-1,3-pentanediol.

22. The surface softening composition according to claim 1 wherein softener active-to-solvent weight ratio is about 8:1.

23. The surface softening composition according to claim 1 wherein softener active-to-solvent weight ratio is about 0.4:1.

24. The surface softening composition according to claim 1 wherein the softener active comprises a quaternary ammonium compound.

25. The surface softening composition according to claim 1 wherein the softener active comprises at least one of:
(a) {R¹₄₋ₘ—N⁺[X—Y—R¹]ₘ}A⁻
wherein each R substituent is a short chain C1-C6 preferably C1-C3 alkyl or hydroxyalkyl group or mixtures thereof; each m is 2 or 3; each Y is —O—(O)C—, or —C(O))—O—; the sum of carbons in each R1, plus one when Y is —O—(O)C—, is C12-C22, preferably C14-C20, with each R1 being a hydrocarbyl, or substituted hydrocarbyl, group, preferably, alkyl, monounsaturated alkylene, and polyunsaturated alkylene groups, with the softener active containing polyunsaturated alkylene groups being at least about 3%, preferably at least about 5%, more preferably at least about 10%, and even more preferably at least about 15%, by weight of the total softener active present; each X is independently —(CH2)n, —CH2-CH(CH3)- or —CH(CH3)-CH2- and each n is from 1 to about 4 and wherein the counterion, A⁻, can be any softener-compatible anion, preferably, chloride, bromide, methyl sulfate, or nitrate, more preferably methyl sulfate;
(b) 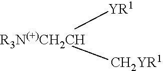
wherein each Y, R, R1, and X(−) have the same meanings as above.

26. The surface softening composition according to claim 1 wherein the softener active comprises [CH₃]3N⁽⁺⁾[CH₂CH(CH₂O(O)CR¹)O(O)CR]CH₃SO₄⁽⁻⁾.

27. The surface softening composition according to claim 1 wherein the softener active is at least one of:
(a) [R₄₋ₘ—N⁽⁺⁾—R¹ₘ]A⁻
wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and where the Iodine Value (hereinafter referred to as “IV”) of a fatty acid containing this R¹ group is from about 60 to about 140, more preferably from about 80 to about 130; and most preferably from about 90 to about 115 with, preferably, a cis/trans ratio of from about 1:1 to about 50:1, the minimum being 1:1, preferably from about 2:1 to about 40:1, more preferably from about 3:1 to about 30:1, and even more preferably from about 4:1 to about 20:1; each R¹ can also preferably be a branched chain C₁₄-C₂₂ alkyl group, preferably a branched chain C₁₆-C₁₈ group; each R is H or a short chain C₁-C₆, preferably C₁₋₃ alkyl or hydroxyalkyl group, e.g., methyl (most preferred), ethyl, propyl, hydroxyethyl, and the like, benzyl, or (R²O)₂₄H where each R² is a C₁₋₆ alkylene group; and A⁻ is a softener compatible anion, preferably, chloride, bromide, methylsulfate, ethylsulfate, sulfate, and nitrate, more preferably chloride and methyl sulfate;
(b) 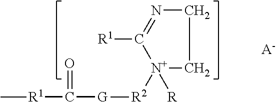
wherein each R, R¹, and A⁻ have the definitions given above; each R² is a C₁₋₆ alkylene group, preferably an ethylene group; and G is an oxygen atom or an —NR— group;
(c) 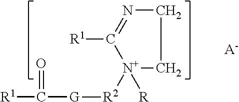
wherein R¹, R² and G are defined as above;
(d) reaction products of substantially unsaturated and/or branched chain higher fatty acids with dialkylenetriamines in, e.g., a molecular ratio of about 2:1, said reaction products containing compounds of the formula:
R¹—C(O)—NH—R²—NH—R³—NH—C(O)—R¹
wherein R¹, R² are defined as above, and each R³ is a C₁₋₆ alkylene group, preferably an ethylene group;
(e) [R¹—C(O)—NR—R²—N(R)₂—R³—NR—C(O)R¹]A⁻
wherein R, R¹, R², R³ and A⁻ are defined as above;
(f) the reaction product of substantially unsaturated and/or branched chain higher fatty acid with hydroxyalkylalkylenediamines in a molecular ratio of about 2:1, said reaction products containing compounds of the formula:
R¹—C(O)—NH—R²—N(R³OH)—C(O)—R¹
wherein R¹, R² and R³ are defined as above;
(g) 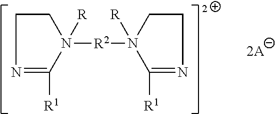
wherein R, R¹, R², and A are defined as above;
(h) acyclic quaternary ammonium salts having the formula:
[R¹—N(R⁵)₂—R⁶]_{+A}⁻
wherein R⁵ and R⁶ are C₁-C₄ alkyl or hydroxyalkyl groups, and R¹ and A⁻ are defined as above;
(i) substituted imidazolinium salts having the formula: 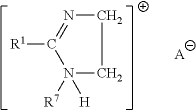
wherein R⁷ is hydrogen or a C₁-C₄ saturated alkyl or hydroxyalkyl group, and R¹ and A⁻ are defined as herein above;
(j) substituted imidazolinium salts having the formula: 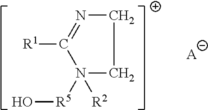
wherein R⁵ is a C₁-C₄ alkyl or hydroxyalkyl group, and R¹, R², and A⁻ are as defined above;
(k) alkylpyridinium salts having the formula: 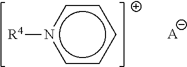
wherein R⁴ is an acyclic aliphatic C₉-C₂₂ hydrocarbon group and A⁻ is an anion; and
(l) alkanamide alkylene pyridinium salts having the formula: 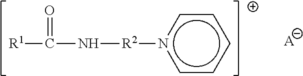
wherein R¹, R² and A⁻ are defined as above;
or mixtures thereof.

28. The surface softening composition according to claim 1 wherein the softener active phase transition temperature is less than 50° C.

29. The surface softening composition according to claim 1 wherein the softener active phase transition temperature is less than 10° C.

30. The surface softening composition according to claim 1 wherein the softener active is amorphous.

31. The surface softening composition according to claim 1 wherein the softener active comprises one or more ester moieties.

32. The surface softening composition according to claim 31 wherein the one or more ester moieties comprises at least one of: mono-esters, di-esters, tri-esters or mixtures thereof.

33. A fibrous structure comprising one or more plies and the surface softening composition of claim 1.

34. A method for treating a fibrous structure, the method comprising the steps of:
a. providing a fibrous structure; and
b. applying a surface softening composition according to claim 1 to at least one surface of the fibrous structure.
